(19) United States
(12) Patent Application Publication
(10) Pub. No.: US 2018/0367566 A1
(43) Pub. Date: Dec. 20, 2018

(54) PREVENTION AND CONTROL METHOD, APPARATUS AND SYSTEM FOR NETWORK ATTACK

(71) Applicant: Alibaba Group Holding Limited, Grand Cayman (KY)

(72) Inventors: Lele Ma, Zhejiang (CN); Yangyang SONG, Zhejiang (CN); Lai ZHOU, Zhejiang (CN)

(21) Appl. No.: 16/115,438

(22) Filed: Aug. 28, 2018

Related U.S. Application Data
(63) Continuation of application No. PCT/CN2017/073716, filed on Feb. 16, 2017.

(30) Foreign Application Priority Data
Feb. 29, 2016 (CN) 201610112465.5

(51) Int. Cl. H04L 29/06; H04L 12/741

(52) U.S. Cl. CPC H04L 63/1458; H04L 63/1416; H04L 63/0236; H04L 45/74; H04L 69/22; H04L 63/20

(57) ABSTRACT

A method including parsing an attack packet when a network attack is detected, wherein the attack packet includes address information; locating a first gateway device according to the address information; and sending a first instruction to the first gateway device, wherein the first instruction is used for instructing the first gateway device to perform security control on a terminal to which the attack packet belongs. The present disclosure solves the technical problem of low defense efficiency when a target server under attack defends passively due to the lack of techniques of monitoring and countering network attacks in conventional techniques.

### CROSS REFERENCE TO RELATED PATENT APPLICATIONS

This application claims priority to and is a continuation of PCT Patent Application No. PCT/CN2017/073716, filed on 16 Feb. 2017, which claims priority to Chinese Patent Application No. 201610112465.5 filed on 29 Feb. 2016 and entitled “PREVENTION AND CONTROL METHOD, APPARATUS AND SYSTEM FOR NETWORK ATTACK”, which are incorporated herein by reference in their entirety.

### TECHNICAL FIELD

The present disclosure relates to the field of communication application technologies, and, more particularly, to prevention and control methods, apparatuses and systems for network attacks.

### BACKGROUND

With the development of the Internet, especially the widespread application of Internet technology, the Internet, which was originally provided as an open platform, is now threatened by network attacks caused by various reasons because of rich resources. Therefore, Internet security has become a problem widely concerned in the Internet era. How to defend against network attacks and counter sources of the network attacks has become a research topic repeatedly explored in the Internet technology.

Among existing network attacks, a Distributed Denial of Service (DDoS) attack is one of the network attacks that are most difficult to defend against. Currently, defense systems in the industry all deploy firewall products at the front end of a server, and clean attacks by using the firewall deployed at the front end of the server when the server is attacked. At present, the biggest problems encountered are as follows. Problem (1): The quantity of attacks is increasing, while the bandwidth at the server side cannot be expanded infinitely, and increasingly more network attacks cannot be alleviated by purely relying on cleaning at the server side. Problem (2): An attacker who initiates a DDoS attack generally may organize a large number of personal computers (PCs) to form a computer network called a botnet, the PCs are generally controlled by the attacker. The botnet is formed by real machines, and there is no effective way to track botnets directly at present. Problem (3): The DDoS network attack cannot be countered, leading to a passive position under attack.

A danger brought about by a DDoS attack is that an attacker will control a large number of zombie hosts to attack a target server, while normal users will not be able to access a target host.

In conventional techniques, mainly the following three methods for alleviating DDoS attacks from a botnet are employed. The first method is a method for detecting a botnet based on an Intrusion Detection System (IDS) and an Intrusion Prevention System (IPS). The IDS monitors the running status of networks and systems according to certain security rules and security strategies. If a machine in a protected network is found to be controlled by an external host, an IDS device can give an alarm according to the configured security strategies and provide a reference for network administrators. The second method is a method for detecting a botnet based on a honeynet technology. The honeypot technology is to intentionally expose an information collection system with some unrepaired loopholes that is arranged by the defender to the network. Once an attacker intrudes, how the attacker implements the intrusion successfully can be known, so as to keep abreast of the latest attacks initiated by hackers and the latest vulnerabilities. The honeypot can also eavesdrop on communication between the hackers, collect a variety of tools used by the hackers, and master their social networks. The third method is a method for monitoring a botnet based on traffic analysis, especially a Deep Packet Inspection (DPI) technology. Some zombie hosts can be found by traffic analysis. The technology only can analyze zombie hosts and botnets in a part of a network, and it is very difficult to locate zombie hosts and botnets over the entire Internet. The technology can neither find all zombie hosts of a particular botnet nor suppress the botnet.

Although the foregoing methods can defend against DDoS attacks, they have the following problems. The first problem is the disadvantage of detecting a botnet based on an IDS and an IPS. The benefit of this method lies in that detection is based on packet-by-packet analysis and an alarm is given by matching the security strategies and rules, but this method can only be used based on a local area network and an enterprise network, and data between single points cannot be shared. Therefore, it is impossible to solve the problem of attack source analysis in large-scale DDoS attacks from the perspective of the detection coverage or speed. The second problem is the disadvantage of capturing a botnet based on a honeypot technology. The honeypot technology requires a lot of deployments and may be easily used by hackers as a springboard. An operating system of a honeypot host has lots of loopholes and is vulnerable to attacks such that the system could not be started. At the same time, data collected by a honeypot system is just a small part of the data of the entire Internet, and only by deploying a large number of honeypot systems can there be enough data for use. This method is generally used for research in practical use, and it is difficult to widely popularize the method. The third problem is the disadvantage of the method for monitoring a botnet based on traffic analysis, especially a DPI detection technology. The DPI technology and the traffic analysis technology described above are lagging, and both the conventional DPI technology and the conventional traffic analysis technology perform analysis and locating by using a device deployed on a server side, and the source of an attack is traced in the last kilometer of the attack. It takes a long time to perform analysis; moreover, as the botnet changes, the previous analysis may soon become untimely and cannot easily keep up with the attacker.

No effective solution has been put forward at present with respect to the problem of low defense efficiency when a target server under attack defends passively due to the lack of techniques of monitoring and countering network attacks in conventional techniques.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide a prevention and control method, apparatus and system for a network attack, to at least solve the technical problem of low defense efficiency when a target server under attack defends passively due to the lack of techniques of monitoring and countering network attacks in conventional techniques.

According to an aspect of the example embodiments of the present disclosure, a prevention and control method for a network attack is provided, including: parsing an attack packet when a network attack is detected, wherein the attack packet includes address information; locating a first gateway device according to the address information; and sending a prevention and control instruction to the first gateway device, wherein the prevention and control instruction is used for instructing the first gateway device to perform security control on a terminal to which the attack packet belongs.

According to an aspect of the example embodiments of the present disclosure, another prevention and control method for a network attack is provided, including: receiving a prevention and control instruction, wherein the prevention and control instruction includes address information of an attack packet received by an attacked server; obtaining by query, according to the address information, an attacking terminal that sends the attack packet; acquiring port information of the attacking terminal, and obtaining, according to the port information, computing devices in communication connection with the attacking terminal; screening, according to the port information, the computing devices in communication connection with the attacking terminal, to obtain an initial terminal that initiates the attack packet, wherein the attacking terminal sends the attack packet according to a control instruction of the initial terminal; and controlling the initial terminal in a preset manner. According to another aspect of the example embodiments of the present disclosure, a prevention and control apparatus for a network attack is provided, including: a parsing module configured to parse an attack packet when a network attack is detected, wherein the attack packet includes address information; a locating module configured to locate a first gateway device according to the address information; and a sending module configured to send a prevention and control instruction to the first gateway device, wherein the prevention and control instruction is used for instructing the first gateway device to perform security control on a terminal to which the attack packet belongs.

According to another aspect of the example embodiments of the present disclosure, another prevention and control apparatus for a network attack is provided, including: a receiving module configured to receive a prevention and control instruction, wherein the prevention and control instruction includes address information of an attack packet received by an attacked server; a query module configured to obtain by query, according to the address information, an attacking terminal that sends the attack packet; an acquisition module configured to acquire port information of the attacking terminal, and obtain, according to the port information, computing devices in communication connection with the attacking terminal; a screening module configured to screen, according to the port information, the computing devices in communication connection with the attacking terminal, to obtain an initial terminal that initiates the attack packet, wherein the attacking terminal sends the attack packet according to a control instruction of the initial terminal; and a prevention and control module configured to control the initial terminal in a preset manner.

According to yet another aspect of the example embodiments of the present disclosure, a prevention and control system for a network attack is provided, including: a server and a local area network device such as a metropolitan area device, the server being in communication connection with the metropolitan area device, wherein the server is the prevention and control apparatus for the network attack described above; and the metropolitan area device is the another prevention and control apparatus for the network attack described above.

In the example embodiments of the present disclosure, an attack packet is parsed when a network attack is detected, wherein the attack packet includes address information; a first gateway device is located according to the address information; and a prevention and control instruction is sent to the first gateway device, wherein the prevention and control instruction is used for instructing the first gateway device to perform security control on a terminal to which the attack packet belongs. Therefore, an objective of actively performing security control on network attacks by a server and a gateway device is achieved, thus achieving a technical effect of improving the defense efficiency, and solving the technical problem of low defense efficiency when a target server under attack defends passively due to the lack of techniques of monitoring and countering network attacks in conventional techniques.

### BRIEF DESCRIPTION OF THE DRAWINGS

The accompanying drawings described here are used to provide a further understanding of the present disclosure, and constitute a part of the present disclosure. The example embodiments of the present disclosure and their descriptions are used to explain the present disclosure, and do not pose any improper limitation to the present disclosure. In the drawings,

FIG. 1 is a block diagram of a hardware structure of a server of a prevention and control method for a network attack according to an example embodiment of the present disclosure;

FIG. 2 is a flowchart of a prevention and control method for a network attack according to Example embodiment 1 of the present disclosure;

FIG. 3 is a schematic structural diagram of a server side in the prevention and control method for a network attack according to Example embodiment 1 of the present disclosure;

FIG. 4 is a distribution diagram of locations of attack packets in the prevention and control method for a network attack according to Example embodiment 1 of the present disclosure;

FIG. 5 is a flowchart of a prevention and control method for a network attack according to Example embodiment 2 of the present disclosure;

FIG. 6 is a flowchart of a prevention and control method for a network attack according to Example embodiment 2 of the present disclosure;

FIG. 7 is a schematic structural diagram of a prevention and control system for a network attack according to an example embodiment of the present disclosure;

FIG. 8 is a schematic flowchart showing that a prevention and control system for a network attack performs a prevention and control method according to an example embodiment of the present disclosure;

FIG. 9 is a schematic structural diagram of a prevention and control apparatus for a network attack according to Example embodiment 3 of the present disclosure;

FIG. 10 is a schematic structural diagram of a prevention and control apparatus for a network attack according to Example embodiment 3 of the present disclosure;

FIG. 11 is a schematic structural diagram of another prevention and control apparatus for a network attack according to Example embodiment 3 of the present disclosure;

FIG. 12 is a schematic structural diagram of yet another prevention and control apparatus for a network attack according to Example embodiment 3 of the present disclosure;

FIG. 13 is a schematic structural diagram of a prevention and control apparatus for a network attack according to Example embodiment 4 of the present disclosure;

FIG. 14 is a schematic structural diagram of a prevention and control apparatus for a network attack according to Example embodiment 4 of the present disclosure;

FIG. 15 is a schematic structural diagram of another prevention and control apparatus for a network attack according to Example embodiment 4 of the present disclosure;

FIG. 16 is a schematic structural diagram of yet another prevention and control apparatus for a network attack according to Example embodiment 4 of the present disclosure; and

FIG. 17 is a schematic structural diagram of a prevention and control system for a network attack according to Example embodiment 5 of the present disclosure.

### DETAILED DESCRIPTION

To enable those skilled in the art to better understand the solutions of the present disclosure, the technical solutions in the example embodiments of the present disclosure will be described below with reference to the accompanying drawings in the example embodiments of the present disclosure. It is obvious that the example embodiments only represent some of rather than all of the example embodiments of the present disclosure. All other example embodiments derived by those of ordinary skill in the art based on the example embodiments of the present disclosure without creative efforts should fall within the protection scope of the present disclosure.

It should be noted that the terms “first”, “second” and so on in the specification, claims and the drawings of the present disclosure are used to distinguish similar objects, but not necessarily to describe a particular order or sequence. It should be understood that such data used can be interchanged under appropriate circumstances, so that the example embodiments described here could be implemented in an order other than the content illustrated or described here. In addition, the terms “comprise/include” and “have” as well as their any variations are intended to cover non-exclusive inclusion, for example, a process, method, system, product or device including a series of steps or units need not be limited to the steps or units clearly listed, but may include other steps or units not clearly listed or inherent to the process, method, system, product or device.

Technical Terms Involved in the Example Embodiments of the Present Disclosure:
DDoS attack: a Distributed Denial of Service (DDoS) attack; and
IP address: a protocol address (Internet Protocol (IP)) for interconnection between networks.

### Example Embodiment 1

According to the example embodiment of the present disclosure, a method example embodiment of a prevention and control method for a network attack is further provided. It should be noted that steps shown in the flowcharts of the accompanying drawings can be performed in a server architecture such as a set of server executable instructions, and the steps shown or described can be performed in an order different from that described here under some circumstances although a logic sequence is shown in the accompanying drawings.

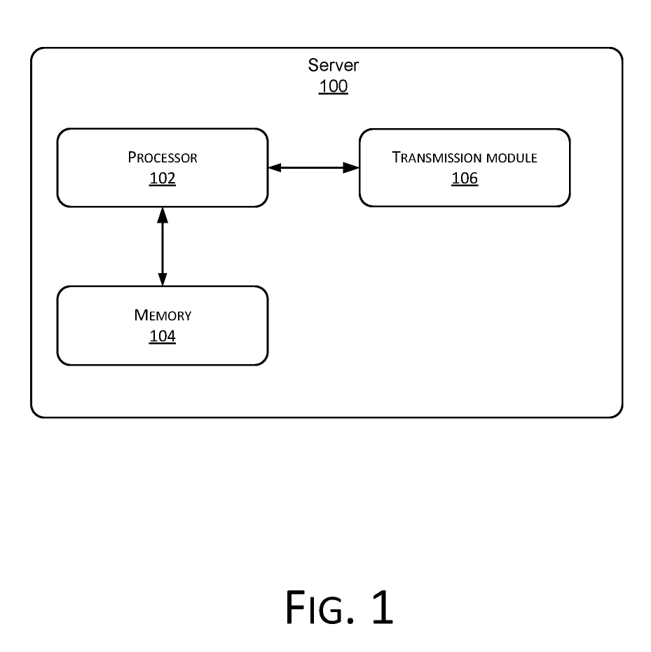

The method example embodiment provided in Example embodiment 1 of the present disclosure can be performed in a server, a gateway device connected to a server cluster or a similar computing device. For example, the method is run on a server. FIG. 1 is a block diagram of a hardware structure of a server of a prevention and control method for a network attack according to an example embodiment of the present disclosure. As shown in FIG. 1, a server 100 may include one or more (only one is shown) processors 102 (the processor 102 may include, but is not limited to, a processing apparatus such as a microprocessor MCU or a programmable logic device FPGA), a memory 104 configured to store data, and a transmission module 106 configured to provide a communication function. Those of ordinary skill in the art can understand that the structure shown in FIG. 1 is only for the purpose of illustration, and does not limit the structure of the above electronic apparatus. For example, the server 100 may further include more or fewer components than those shown in FIG. 1, or have a configuration different from that shown in FIG. 1.

The memory 104 can be configured to store a software program and module of an application, for example, program instructions/modules corresponding to the prevention and control method for a network attack in the example embodiment of the present disclosure. The processor 102 runs the computer readable instructions or software program and module stored in the memory 104, to implement various functional applications and data processing, that is, implement the method for detecting vulnerabilities of the application. The memory 104 may include a high-speed random access memory, and may also include a nonvolatile memory, for example, one or more magnetic storage devices, flash memories or other nonvolatile solid-state memories. In some examples, the memory 104 may further include memories remotely disposed relative to the processor 102, and these remote memories may be connected to the server 10 through a network. Examples of the network include, but are not limited to, the Internet, an intranet, a local area network, a mobile communications network, or a combination of them.

The memory 104 is an example of the computer readable medium. The computer readable medium includes non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition herein, the computer readable medium does not include transitory media, such as modulated data signals and carriers.

The transmission module 106 is configured to receive or send data via a network. For example, the network may include a wireless network provided by a communication provider of the server 10. In an example, the transmission module 106 includes a Network Interface Controller (NIC), which can be connected to another network device through a base station, so as to communicate with the Internet. In an example, the transmission module 106 may be a Radio Frequency (RF) module, which is configured to communicate with the Internet in a wireless manner.

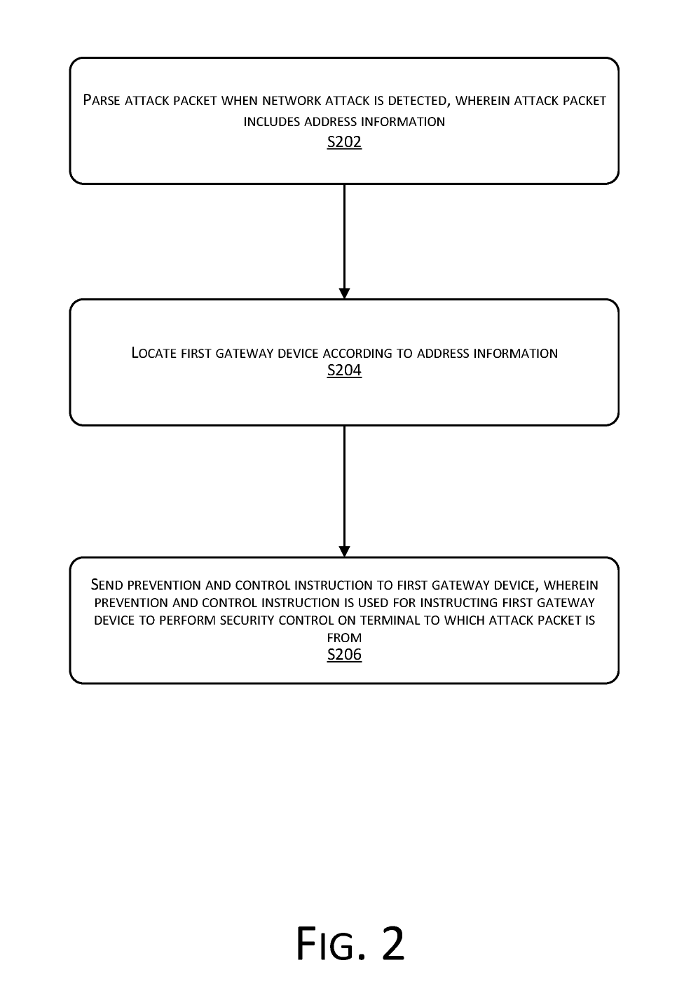

In the above running environment, the present disclosure provides a prevention and control method for a network attack as shown in FIG. 2. At a server side, FIG. 2 is a flowchart of a prevention and control method for a network attack according to Example embodiment 1 of the present disclosure.

Step S202. An attack packet is parsed when a network attack is detected, wherein the attack packet includes address information.

The prevention and control method for a network attack according to the example embodiment of the present disclosure can be applied to an environment of the Internet or an intercity local area network. In the present disclosure, descriptions are given by using a DDoS attack as an example. In the process directed to the DDoS attack, a server end denies attacks only relying on a firewall deployed at the front end of the server in conventional techniques. However, as the quantity of attacks is increasing, passive defense of the firewall will not be able to meet defense requirements. With respect to the characteristics of the DDoS attack, an attacker who initiates the DDoS attack generally may organize a large number of Personal Computers (PCs) to form a botnet, and the PCs are generally controlled by the attacker. Then, the attacker attacks the server by controlling the botnet, increasing the quantity of attacks. To effectively alleviate the influence caused by DDoS attacks, the prevention and control method for a network attack according to the example embodiment of the present disclosure disposes, at the server side, a cleaning system at the front end of the server. In addition to being distinguished from the passive defense in conventional techniques, the server will perform security control actively on DDoS attacks.

In step S202 of the present disclosure, when a network attack is detected at the server side, address information in an attack packet is obtained by parsing the attack packet that forms the network attack, wherein the address information can indicate a source location of the attack packet. In the present disclosure, the source location may be the city to which a terminal sending the attack packet belongs. Step S204 is performed.

Step S204. A first gateway device is located according to the address information.

Based on the address information in the attack information acquired in step S202, in step S204 of the present disclosure, the address information in the example embodiment of the present disclosure may include an IP address. Based on an Internet address protocol, a network packet will carry a source address and a destination address (which may be an IP address or a Media Access Control (MAC) address) during sending of the network packet. At the server side, as the attack packet is also a network packet, a location of a source IP address can be determined based on an existing IP protocol according to the IP address in the attack packet when the server receives the attack packet. The address information provided in the example embodiment of the present disclosure is described by using an IP address as an example, which is not specifically limited as long as the prevention and control method for a network attack according to the example embodiment of the present disclosure can be implemented.

Step S206. A prevention and control instruction is sent to the first gateway device, wherein the prevention and control instruction is used for instructing the first gateway device to perform security control on a terminal to which the attack packet is from.

Based on the location of the attack packet determined in step S204, in step S206 of the present disclosure, after the location of the attack packet is determined, the server side will generate the prevention and control instruction and send the prevention and control instruction to the first gateway device located at the location, such that the first gateway device actively performs, according to the prevention and control instruction, security control on a terminal that initiates the attack packet, thus restraining the attack source of the network attack that the current server side faces, that is, the first gateway device actively performs defense control on the current network attack.

Here, in the prevention and control method for a network attack according to the example embodiment of the present disclosure, the example embodiment of the present disclosure deploys a cleaning system at a server side and a metropolitan area device side respectively. When the server side is subject to a network attack, the server side will actively analyze an attack source in addition to passive defense, and counter the network attack in cooperation with the metropolitan area device. That is, a prevention and control instruction is sent to the metropolitan area device to which the terminal initiating the attack packet belongs, such that the metropolitan area device restrains the current network attack at the source, thus achieving active defense against network attacks, reducing the bandwidth usage during the passive defense, and improving the efficiency of defense against network attacks. The metropolitan area device may be gateway devices deployed in various cities or various network nodes.

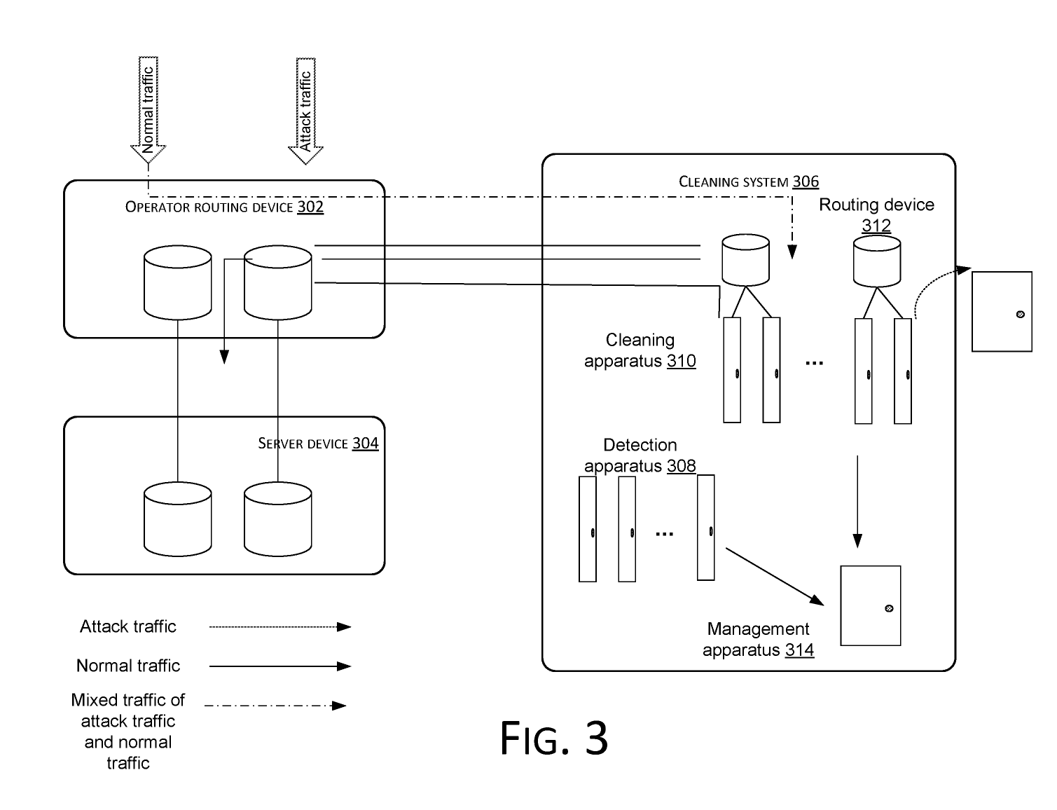

In combination with step S202 to step S206, FIG. 3 is a schematic structural diagram of a server side in the prevention and control method for a network attack according to Example embodiment 1 of the present disclosure. As shown in FIG. 3, the defense architecture at the server side provided in the example embodiment of the present disclosure includes an operator routing device 302, a server device 304, and a cleaning system 306, wherein the cleaning system may include a detection apparatus, a cleaning apparatus 310, a routing device 312, and a management apparatus 314. The operator running device 302 may be installed at the side of the operator such as Internet Service Provider (ISP). Here, the management apparatus 314 is configured to manage the detection apparatus and the cleaning apparatus. When the operator routing device 302 receives traffic information, which may include normal traffic, attack traffic, or a mixed traffic of the attack traffic and the normal traffic, the cleaning system 306 in communication connection to the operator routing device 302 will receive all current traffic information by using the routing device 312, and control, by using the management apparatus 314, the detection apparatus 308 to detect the traffic information received currently, screen out attack traffic, then clean the attack traffic by using the cleaning apparatus 310, to return normal traffic to the server device 304, that is, traffic information not containing attack traffic, and send a prevention and control instruction to the location to which the attack traffic is from, to start active prevention and control.

In the prevention and control method for a network attack according to the example embodiment of the present disclosure, after a network attack is detected in step S202 (that is, the detection apparatus in the cleaning system in FIG. 3), an attack packet is parsed. The location of the attack packet is located in step S204. Then, cleaning is started to first alleviate the current network attack while a prevention and control instruction is sent to a first gateway device in the location in step S206. Thus, the terminal sending the attack packet is actively controlled by tracing to the source at the side of the first gateway device, to perform active defense. The problem in conventional techniques that the server side can perform passive defense only relying on the firewall is avoided, and the defense efficiency is improved.

It is thus clear that according to the solution provided in Example embodiment 1 of the present disclosure, an attack packet is parsed when a network attack is detected, wherein the attack packet includes address information; a first gateway device is located according to the address information; and a prevention and control instruction is sent to the first gateway device, wherein the prevention and control instruction is used for instructing the first gateway device to perform security control on a terminal to which the attack packet belongs. Therefore, an objective of actively performing security control on network attacks by a server and a gateway device is achieved, thus achieving a technical effect of improving the defense efficiency, and solving the technical problem of low defense efficiency when a target server under attack defends passively due to the lack of techniques of monitoring and countering network attacks in conventional techniques.

In an example embodiment, the step of parsing an attack packet in step S202 includes the following steps.

In the prevention and control method for a network attack according to the example embodiment of the present disclosure, how to parse an attack packet based on step S202 is, for example, as follows:

Step1. The attack packet is collected within a preset unit time.

In step Step1 of the present disclosure, when attack information of the attack packet is acquired, it is necessary to first screen out the attack packet. That is, a conventional network packet may not be sent frequently to a server side within a short period of time. On this basis, when it is collected in unit time that source addresses from which a network packet is sent are a same address, packet protocol types are the same and the packet length is greater than a preset length, the network packet is determined as an attack packet. The preset unit time in the example embodiment of the present disclosure may be a packet collection time as shown in Table 1. In the process of judging whether a network packet is an attack packet in the example embodiment of the present disclosure, a packet of which source addresses within a collection time are the same, packet protocol types are the same and the packet length is greater than a preset length is judged as an attack packet. Table 1 is a list of network packets collected in unit time:

TABLE 1

| | | Source | Destination | | | |
|---|---|---|---|---|---|---|
| Number | Time | address | address | Protocol | Length | Domain |
| 1 | 6:XX:XX | 122.X.X | 42 | SSDP | 422 | HTTP/ |
| | on | | | | | 1.1 |
| | July 11, 0X | | | | | 200 OK |
| 2 | 6:XX:XX | 113.X.X | 42 | SSDP | 310 | HTTP/ |
| | on | | | | | 1.1 |
| | July 11, 0X | | | | | 200 OK |
| 3 | 6:XX:XX | 113.X.X | 42 | SSDP | 356 | HTTP/ |
| | on | | | | | 1.1 |
| | July 11, 0X | | | | | 200 OK |
| 4 | 6:XX:XX | 121.X.X | 42.X.X | SSDP | 284 | HTTP/ |
| | on | | | | | 1.1 |
| | July 11, 0X | | | | | 200 OK |
| . . . | . . . | . . . | . . . | . . . | . . . | . . . |
| X | 6:XX:XX | 113.X.X | 42.X.X | SSDP | 364 | HTTP/ |
| | on | | | | | 1.1 |
| | July 11, 0X | | | | | 200 OK |

As can be known from Table 1 that that 6:XX:XX on July 11, 0X is a packet collection time is used as an example. As shown in Table 1, at the time point, the source address 113.X.X sends multiple (more than two) network packets and the packet length is greater than an average value of all packet lengths received. Thus, it can be obtained that the network packet of which the source address is 113.X.X and the protocol type is a Simple Service Discovery Protocol (SSDP) is an attack packet.

Step2. The attack packet is parsed to obtain the address information and traffic information of the attack packet.

Based on the attack packet collected in step Step1, in step Step2 of the present disclosure, the address information and traffic information of the attack packet will be obtained by parsing the attack packet, wherein the traffic information may be a percentage that the attack packet currently accounts for in a Hypertext Transfer Protocol (HTP) data packet of all User Datagram Protocols (UDPs) and a bit ratio. The address information may be a source address in the foregoing Table 1. Descriptions are given by using that the source address is an IP address as an example in the example embodiment of the present disclosure.

Step3. An attack feature of the attack packet is obtained according to the traffic information and the address information, wherein the attack feature is a manner of impacting the traffic of a server by the attack packet based on the address information within the preset unit time.

In step Step3 of the present disclosure, after traffic information and address information are obtained in combination with Step1 and Step2, an attack feature of the attack packet having the address information 113.X.X can be obtained in a unit time in step Step1. That is, an attack feature of the attack packet is obtained by calculation according to the source address of the attack packet and the traffic information in Step2 in unit time, wherein the attack feature can include sending a large number of SSDP packets at a high frequency, that is, a feature of SSDP reflection attack is formed.

Further, in an example embodiment, the step of locating a first gateway device according to the address information in step S204 includes:

Step1. The address information is parsed to obtain a source address of the attack packet.

Based on the address information obtained in Step2 of step S202, in step Step1 of the present disclosure, the address information can include a source address, a source port, a destination address, and a destination port. The destination address can be an IP address at a server side. The destination port can be a port through which the server side receives an attack packet. As the attack packet is received at the server side, the destination address is known at the server side as the IP address of the server, and a source address will be obtained by parsing the address information.

Step2. A location corresponding to the source address is matched in a preset database to obtain a location to which the attack packet belongs.

After the source address of the attack packet is obtained based on step Step1, in step Step2 of the present disclosure, a location corresponding to an IP address, that is, the city to which the IP belongs, can be obtained by query through the IP address under the Internet Protocol framework. It is thus clear that in the example embodiment of the present disclosure, the province and the city to which the source address belongs will be obtained by matching the source address in a database.

Step3. The database is queried for a gateway device corresponding to the location, to obtain the first gateway device corresponding to the location to which the attack packet belongs.

Based on the location to which the attack packet belongs determined in step Step2, in step Step3 of the present disclosure, based on the Internet protocol framework, when the city (that is, the location in the example embodiment of the present disclosure) to which the source IP belongs is obtained through the source IP address, a first gateway device that forwards an attack packet carrying the source IP is obtained by cooperating with an operator of the city.

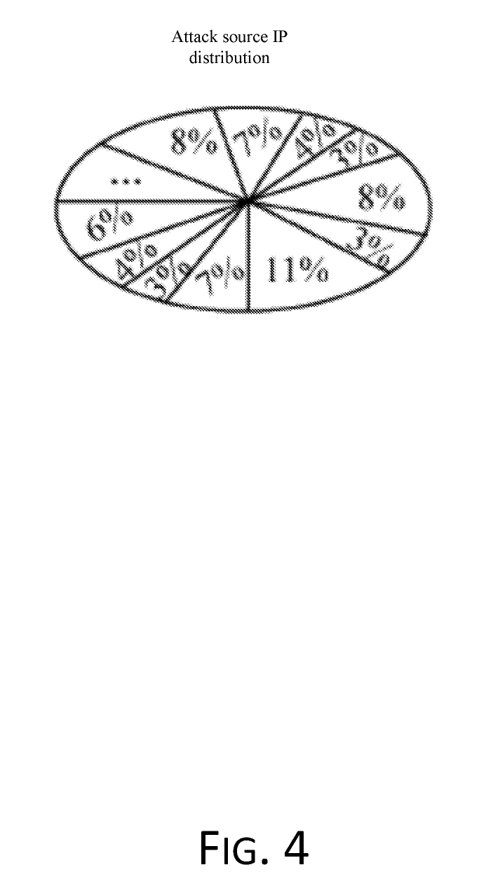

FIG. 4 is a distribution diagram of locations of attack packets in the prevention and control method for a network attack according to Example embodiment 1 of the present disclosure. As shown in FIG. 4, a city and/or operator with the largest attack source among attack packets received at a server side may be obtained by a pie chart distribution, and once the city with the largest attack source is known, security control may be performed on a terminal indicated by a source address in the city area by cooperating with a gateway device deployed in the city, achieving the effect of active defense. The city with the largest percentage of attack source IP distribution may be the city with the largest attack source, which is the city corresponding to 11% as shown in FIG. 4. It should be noted here that after the operator information is acquired, the operator resources may be used to further determine a matching prevention and control strategy for the terminal that sends the attack packet, to achieve an optimal prevention and control effect. Step S206 is performed for detailed prevention and control.

Further, in an example embodiment, step S206 of sending a prevention and control instruction to the located gateway device includes:

Step1. A prevention and control instruction is generated according to the attack feature.

Based on the location of the attack packet determined in step S204, in step Step1 of the present disclosure, a prevention and control instruction will be generated according to the attack feature obtained in step S204. The prevention and control instruction may include a local prevention and control instruction and a prevention and control instruction executed by the gateway device indicating the location to which the attack packet belongs.

The local prevention and control instruction is a defense operation performed at the server side, and the defense operation may include: setting a white list or setting a threshold for data traffic received at the server side.

Here, source IP addresses except the white list are screened by setting the white list. When a network packet carrying an attack feature is acquired, receiving of a network packet of a source IP corresponding to the attack feature is forbidden. The white list is expanded by screening and learning. Likewise, a black list is processed in the same manner. A source IP carrying an attack feature is marked, a black list is generated according to the source IP, and receiving of a network packet from the source IP address is forbidden.

In the local prevention and control instruction, after the city is located, a type of the attack source and the characteristics of a host system may be further analyzed, for example, a NAT intranet IP, a forged crawler IP, a proxy IP, a personal zombie host, a server zombie host, and a 3G gateway. For different types, different strategies are adopted at the server side (that is, the near destination end), and local defense processing is performed according to different IP strategies. The IP strategy may include: adopting a speed-limit strategy for a NAT intranet IP and a 3G gateway, and a blocking strategy for other IPs.

By setting a threshold, a data packet of which the data receiving traffic is greater than the current threshold may be discarded, to ensure the security of the server side. Here, the local prevention and control instruction executed at the server side is passive defense. The objective of active defense is achieved by generating the prevention and control instruction executed by the gateway device configured to indicate the location to which the attack packet belongs and cooperating with a gateway device corresponding to the location to which the attack packet belongs.

Step2. The prevention and control instruction is sent to the first gateway device.

In combination with the prevention and control instruction obtained by Step1 in step S206, and after the first gateway device corresponding to the location to which the attack packet belongs is obtained, the prevention and control instruction is sent to the first gateway device in step Step2 of the present disclosure, wherein the first gateway device is a metropolitan area gateway device equipped with a cleaning system. For example, a traffic cleaning system is deployed at each metropolitan area network egress such that the cleaning system establishes a Border Gateway Protocol (BGP) neighbor relationship with a router of the metropolitan area network egress.

It should be noted that in the prevention and control method for a network attack provided in the example embodiment of the present disclosure, the example embodiment of the present disclosure provides a prevention and control network, which is different from the passive defense at the server side in conventional techniques. In the prevention and control network, a cleaning system is also deployed at the metropolitan area device side in addition to at the server side. As a result, when the server side detects a network attack, the source of the entire attack process, i.e., the initiating terminal of the entire network attack, is obtained by locating the city to which the initiating terminal of the attack packet belongs and cooperating with the metropolitan area device of the city to perform tracing and screening according to attack information of the attack packet. Security control is performed on the initiating terminal through the cleaning system of the metropolitan area device, to eliminate the attack network composed of the initiating terminal and completely eradicate a network attack initiated by the initiating terminal once again. Different from the passive defense at the server side in conventional techniques, in the prevention and control method for a network attack provided in the example embodiment of the present disclosure, in addition to the conventional prevention and control, the server side also acquires the source IP of the attack packet actively, performs locating, and cooperates with the metropolitan area device corresponding to the location to which the source IP belongs, thus achieving the effect of active defense, and enhancing the defense efficiency of the server side when facing network attacks.

### Example Embodiment 2

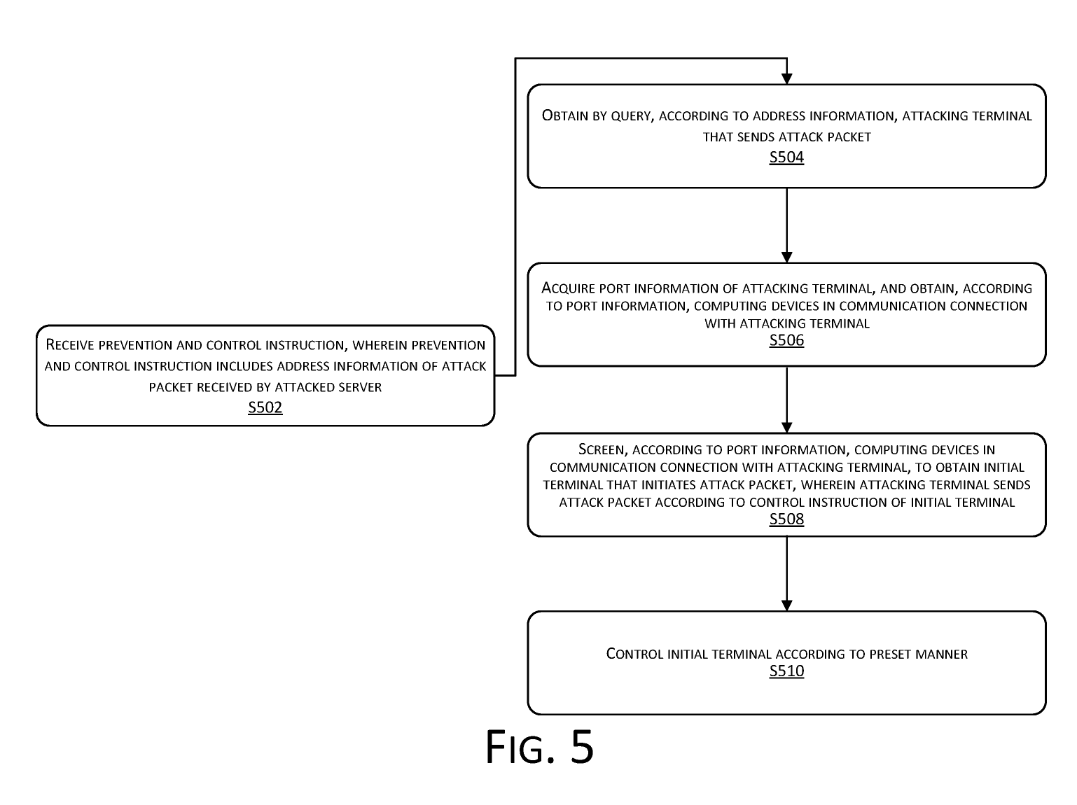

According to the example embodiment of the present disclosure, another method example embodiment of a prevention and control method for a network attack is further provided. The present disclosure provides a prevention and control method for a network attack as shown in FIG. 5 at a metropolitan area device side. FIG. 5 is a flowchart of a prevention and control method for a network attack according to Example embodiment 2 of the present disclosure.

Step S502. A prevention and control instruction is received, wherein the prevention and control instruction includes address information of an attack packet received by an attacked server.

The prevention and control method for a network attack provided in the example embodiment of the present disclosure may be applied to the metropolitan area device side, wherein the metropolitan area device may be a gateway device of each metropolitan area network. In the example embodiment of the present disclosure, the gateway device is a gateway device equipped with a cleaning system, wherein the cleaning system establishes a Border Gateway Protocol (BGP) neighbor relationship with a router of the metropolitan network egress.

In step S502 of the present disclosure, the metropolitan area device receives a prevention and control instruction sent by a server, and the metropolitan area device acquires address information of an attack packet received by an attacked server through the prevention and control instruction.

Step S504. An attacking terminal that sends the attack packet is obtained by query according to the address information.

Based on the address information in the prevention and control instruction in step S502, in step S504 of the present disclosure, the metropolitan area device obtains by query, according to the address information, the attacking terminal that sends the attack packet, wherein the source address in the address information may be obtained by query according to the address information in the attack packet, and here, the terminal that sends the attack packet may be obtained by query according to the source address.

For example, based on the Internet protocol framework, a network packet during transmission may carry a source address and a destination addresses and/or a source port and a destination port as well as a protocol type of the network packet. Therefore, after the metropolitan area device receives the prevention and control instruction, as the prevention and control instruction carries address information of the attack packet, the metropolitan area device may obtain by query, according to the address information, the attacking terminal that sends the attack packet. That is, the server receives the attack packet, the destination address and the destination port of the attack packet will be an IP address and a port of the server, an IP address and a port of the terminal that sends the attack packet may be obtained according to the source address and the source port in the address information in the attack packet, and the metropolitan area device also obtains, according to the source address and the source port, the attacking terminal that sends the attack packet.

Here, the prevention and control method for a network attack provided in the example embodiment of the present disclosure is illustrated by using a DDoS attack as an example, but the present disclosure is not limited specifically thereto, as long as the prevention and control method for a network attack provided in the example embodiment of the present disclosure may be implemented.

Step S506. Port information of the attacking terminal is acquired, and computing devices in communication connection with the attacking terminal are obtained according to the port information.

Based on the attacking terminal obtained by query in step S506, in step S506 of the present disclosure, the port information of the attacking terminal is acquired at first, and then all computing devices that are in communication connection with the attacking terminal are acquired according to the port information. Here, the computing device may be an initial terminal suspected of initiating the entire network attack.

For example, by acquiring the port information of the attacking terminal, the metropolitan area device may obtain the number and distribution of the computing devices that are in communication connection with the attacking terminal. That is, there are multiple computing devices that are in communication connection with the attacking terminal in the Internet communication, and the initial terminal that initiates the entire network attack will exist in the multiple computing devices that are in communication connection with the attacking terminal. The computing device in the example embodiment of the present disclosure is the dame as the attacking terminal and the initial terminal, and may be a PC, a notebook, a supercomputer, or other computing device that may access a communication network. The example embodiment of the present disclosure is described only by using a PC as an example, which is subject to the implementation of the prevention and control method for a network attack provided in the example embodiment of the present disclosure, and is not limited specifically.

Step S508. The computing devices in communication connection with the attacking terminal are screened according to the port information, to obtain an initial terminal that initiates the attack packet, wherein the attacking terminal sends the attack packet according to a control instruction of the initial terminal.

Based on the computing device obtained in step S506, in step S508 of the present disclosure, when a network attack takes place at the metropolitan area device side, two places where a communication packet exists between the attacking terminal sending the attack packet and the computing devices in communication connection with the attacking terminal may be detected. One is a metropolitan network egress where the computing device in communication connection with the attacking terminal locates. The other is a metropolitan network egress where the attacking terminal sending the attack packet locates. The terminal in communication connection with the attacking terminal may be the computing device in step S506, because the computing devices in communication connection with the attacking terminal may be multiple terminals, especially computing devices that communicate with the attacking terminal multiple times before and when a network attack takes place.

Here, how to obtain by screening an initial terminal from multiple computing devices may include: when an attacking terminal attacks a server, firstly, an attack instruction (that is, the control instruction mentioned in the example embodiment of the present disclosure) is acquired from the initial terminal. The attack instruction may include an attack type, attack duration, attack traffic and the like. As the initial terminal needs to send the attack instruction to a large number of attacking terminals before attack, the existence of the initial terminal may be judged by a sharp rise of the traffic of a same IP port within a certain period of time, and the initial terminal may be located.

Step S510. The initial terminal is controlled according to a preset manner.

In step S510 in the present disclosure, the metropolitan area device may obtain the device type of the initial terminal according to the attack manner of the initial terminal, and further match the corresponding security control method according to the device type.

The metropolitan area device performs a prevention and control strategy by controlling the initial terminal, wherein the controlling the initial terminal may be that the metropolitan area device corresponding to the initial terminal regulates the authority of the initial terminal, for example, any attacking terminal in communication connection with the attacking terminal is turned off, such that the initial terminal is isolated from the outside. Further, by performing the prevention and control strategy and breaking off communication links between attacking terminals in an attack network composed of the initial terminal and multiple attacking terminals that send attack packets, black-hole processing is performed on the initial terminal, so that the entire attack network loses the attack capability.

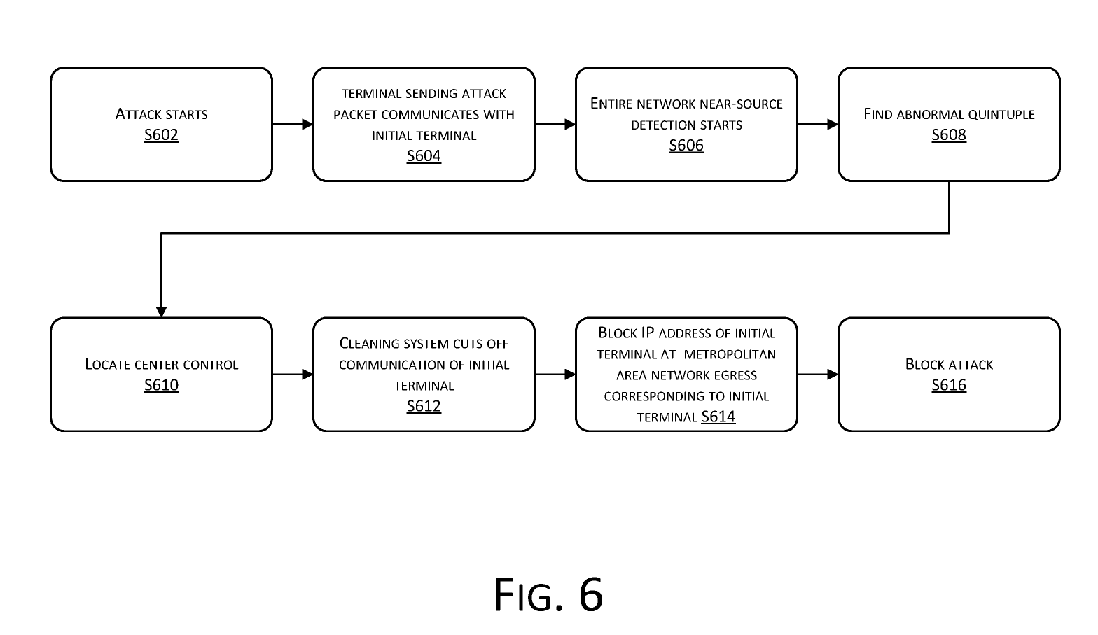

For example, referring to FIG. 6, FIG. 6 is a flowchart of a prevention and control method for a network attack according to Example embodiment 2 of the present disclosure. At 602, an attack starts. At 604, a terminal sending an attack packet communicate with an initial terminal. At 606, the entire network near-source detection starts. At 608, an abnormal quintuple is found. At 610, a center control is located. At 612, the cleaning system cuts off communication of the initial terminal. At 614, the IP address of the initial terminal is blocked at the metropolitan area network egress corresponding to the initial terminal. At 616, the attack is blocked.

As shown in FIG. 6, at a metropolitan area device side, after a server detects a network attack, the metropolitan area device receives a prevention and control instruction sent by the server, and the metropolitan area device performs whole network near-source detection on computing devices which establish communication connection with an attacking terminal that sends the attack packet, further locates an initial terminal of the entire network attack by finding an abnormal quintuple. Then a cleaning system cuts off the communication of the initial terminal, thus blocking (that is, black-hole processing) the IP of the initial terminal at the egress of the metropolitan network, and finally achieving the effect of interrupting the network attack, to avoid the passive defense of the server in conventional techniques, and further achieve the objective that the server and the metropolitan area device actively defend against network attacks by cooperation in the prevention and control method for a network attack provided in the example embodiment of the present disclosure. The quintuple provided in the example embodiment of the present disclosure may include: (1) a source IP address; (2) a destination IP address; (3) a source port; (4) a destination port; and (5) a protocol type. The metropolitan area devices spread all over detect whether the data traffic between the source IP address, the destination IP address, the source port and the destination port is greater than a preset threshold, computing devices in communication connection with the attacking terminal that sends the attack packet may be obtained, and then the computing devices are screened to obtain the initial terminal that initiates the entire network attack.

It is thus clear that according to the solution provided in Example embodiment 2 of the present disclosure, a prevention and control instruction is received, wherein the prevention and control instruction includes address information of an attack packet received by an attacked server; an attacking terminal that sends the attack packet is obtained by query according to the address information; port information of the attacking terminal is acquired, and computing devices in communication connection with the attacking terminal are obtained according to the port information; the computing devices in communication connection with the attacking terminal are screened according to the port information, to obtain an initial terminal that initiates the attack packet, wherein the attacking terminal sends the attack packet according to a control instruction of the initial terminal; and the initial terminal is controlled in a preset manner. Therefore, the objective of actively performing security control on network attacks by a server and a gateway device is achieved, thus achieving the technical effect of improving the defense efficiency, and solving the technical problem of low defense efficiency when a target server under attack defends passively due to the lack of techniques of monitoring and countering network attacks in conventional techniques.

In an example embodiment, step S506 of obtaining, according to the port information, computing devices in communication connection with the attacking terminal includes:

Step1. Computing devices that communicate with the attacking terminal before the prevention and control instruction is received are queried for according to the port information.

In step Step1 of the present disclosure, the metropolitan area device queries for, according to the port information, the computing devices that communicate with the attacking terminal before the prevention and control instruction is received, that is, an initial terminal suspected of initiating the entire network attack exists.

For example, through the port information, the metropolitan area device may obtain information of a communication port of each computing device which has established a communication connection with the attacking terminal that sends the attack packet, and by marking the computing devices in communication connection with the attacking terminal that sends the attack packet, the initial terminal that actually initiates the entire network attack is obtained by screening. The initial terminal is acquired by performing step S508.

In an example embodiment, step S508 of screening, according to the port information, the computing devices in communication connection with the attacking terminal, to obtain an initial terminal that initiates the attack packet includes:

Step1. When the port information includes a source address, a destination address, a source port, a destination port and a protocol type, an address of the attacking terminal is used as the destination address, and a source address that communicates with the destination address within a preset time for a number of times that is greater than a preset security value is detected.

Based on Step1 in step S506, in step Step1 of the present disclosure, the prevention and control method for a network attack provided in the example embodiment of the present disclosure proposes a concept of quintuple. That is, the quintuple includes: (1) a source IP address; (2) a destination IP address; (3) a source port; (4) a destination port; and (5) a protocol type. The metropolitan area device acquires port information, i.e., quintuple information between the attacking terminal and each computing device.

For example, the metropolitan area device detects a source address that uses an address of the attacking terminal as a destination address, wherein the number of times the source address communicates with the destination address within a preset time is greater than a preset security value, as shown in Table 2. Table 2 is quintuple information indicating that the communication between an attacking terminal sending an attack packet and each computing device is established, wherein the attacking terminal is captured at the metropolitan network egress before an attack. The source address and the destination address in the example embodiment of the present disclosure uses the IP address as an example.

TABLE 2

| Source | Destination | Source | Destination | Protocol |
|---|---|---|---|---|
| IP | IP | Port | Port | Type |
| 211.21.21.2 | 119.20.20.20 | 65403 | 50000 | TCP |
| 211.21.21.3 | 119.20.20.20 | 62123 | 50000 | TCP |
| 211.21.21.4 | 119.20.20.20 | 63234 | 50000 | TCP |
| 211.21.21.5 | 119.20.20.20 | 61111 | 50000 | TCP |
| 211.21.21.6 | 119.20.20.20 | 54321 | 50000 | TCP |
| 211.21.21.7 | 119.20.20.20 | 12345 | 50000 | TCP |
| 211.21.21.8 | 119.20.20.20 | 22345 | 50000 | TCP |

As shown in table 2, before receiving the prevention and control instruction, if the metropolitan area device detects that a source IP in Table 2 is always in communication with a destination IP within a short period of time, and the port is fixed, the source IP may be determined as the IP of the initial terminal that initiates the entire network attack. Here, the short period of time may be within a preset communication period, wherein the communication period may be determined according to an actual communication environment.

Step2. The computing device corresponding to the source address with the number of times of communication greater than the preset security value is used as the initial terminal.

Based on the source address detected within the preset time in step Step1, in the above Step2 of the present disclosure, if a network attack is initiated, the initial terminal needs to frequently communicate with the attacking terminal that sends the attack packet, to inform the attacking terminal of the attack instruction; therefore, the computing device corresponding to the source address with the number of times of communication greater than the preset security value is used as the initial terminal, and the locating of the initial terminal is completed.

Further, in an example embodiment, when the prevention and control instruction further includes an attack feature, step S510 of controlling the initial terminal in a preset manner includes:

Step1. A device type of the initial terminal is acquired.

Based on the initial terminal obtained in step S508, in step Step1 of the present disclosure, as the cleaning system and the traffic detection system are deployed on the metropolitan area device side, the metropolitan area device acquires the device type of the initial terminal.

Step2. A corresponding prevention and control strategy is matched in a preset database according to the attack feature and the device type when the attack feature is a manner of impacting the traffic of a server by the attack packet based on the address information within a preset unit time.

Based on the device type acquired in step Step1, in step Step2 of the present disclosure, based on the cleaning system deployed in the metropolitan area device in advance, the cleaning system (that is, the preset database of the present disclosure) matches the prevention and control strategy corresponding to the initial terminal according to the attack feature and the device type.

Step3. A communication link between the attacking terminal and the initial terminal is interrupted.

In step Step3 of the present disclosure, the metropolitan area device will interrupt the communication link between the attacking terminal that sends the attack packet and the initial terminal, to achieve the effect of breaking off the communication connection between the attack network composed of multiple attacking terminals and the initial terminal of the attack source. As the communication connection between the attack network and the attack source is broken off, the attack network will not be able to continue to receive the attack instruction sent by the initial terminal, and the attack network will be paralyzed when performing the attack behavior and then crumbled, which eliminates the current DDoS attack.

Step4. The initial terminal is blocked according to the prevention and control strategy.

In step Step4 of the present disclosure, while the communication link between the attacking terminal and the initial terminal is interrupted, the initial terminal may be blocked. For example, the IP address of the initial terminal may be blocked such that the IP address becomes an invalid address, thus eliminating the possibility that the initial terminal communicates with any attacking terminal.

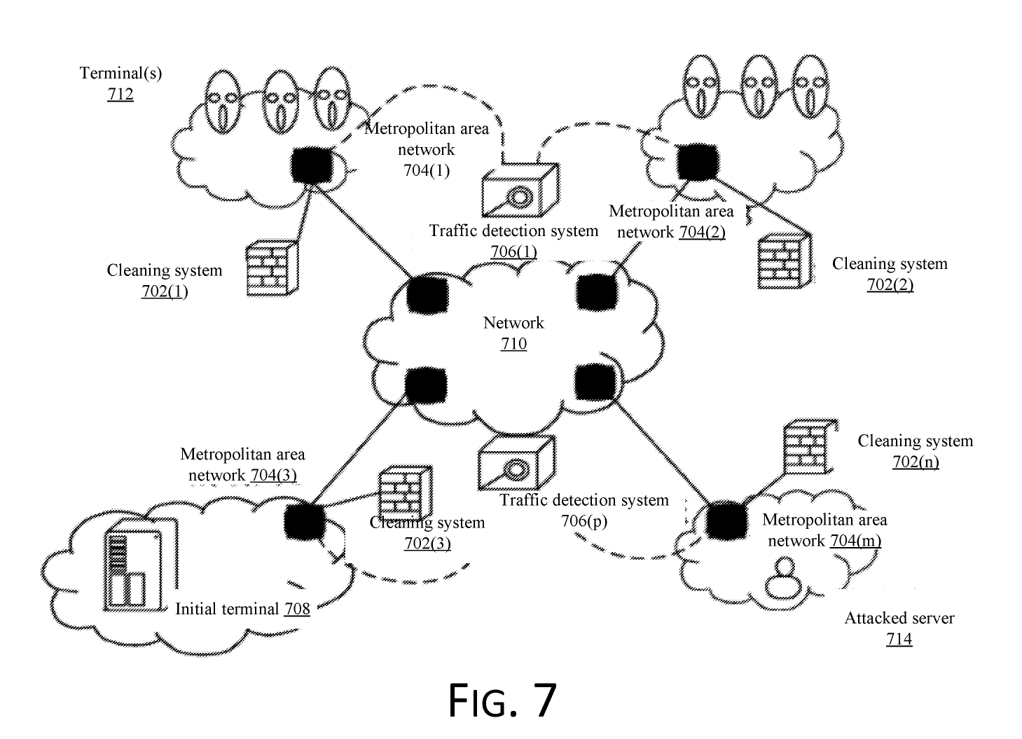

It should be noted that in combination with Example embodiment 1 and Example embodiment 2, the cooperative defense between the server side and the metropolitan area device side avoids the current situation in conventional techniques that the server may only defend passively. Further, with the prevention and control method for the network attack provided in the example embodiment of the present disclosure, the server and the metropolitan area device perform security control on the network attack actively, which enhances the defense efficiency. For example, the present disclosure provides a defense architecture, as shown in FIG. 7. FIG. 7 is a schematic structural diagram of a prevention and control system for a network attack according to an example embodiment of the present disclosure. In FIG. 7, cleaning systems 702(1), 702 (2), 702(3), . . . 702(n), n may be any integer, are deployed at each of the metropolitan network egresses respectively, to enable the cleaning system to establish a BGP neighbor relationship with a router of the metropolitan network egress. The corresponding metropolitan area networks include metropolitan area network 704(1), 704(2), 704(3), . . . 704(m), m may be any integer. Moreover, each metropolitan network is provided with a traffic detection system such as traffic detection system 706(1), 706(p), p may be any integer, wherein the metropolitan network sends traffic information of the egress router to the traffic detection system 706, so that an initial terminal 708 may be effectively detected according to the port information (that is, quintuple) when a network attack takes place. The various metropolitan area networks are just examples of local area networks which may be any size. These local area networks are connected together via a network 710. Each local area network may include one or more terminals, such as terminal(s) 712 in the metropolitan area network 704(1). The attack server may be located in any of the local area networks, such as an attacked server 714 in the metropolitan area network 704(m).

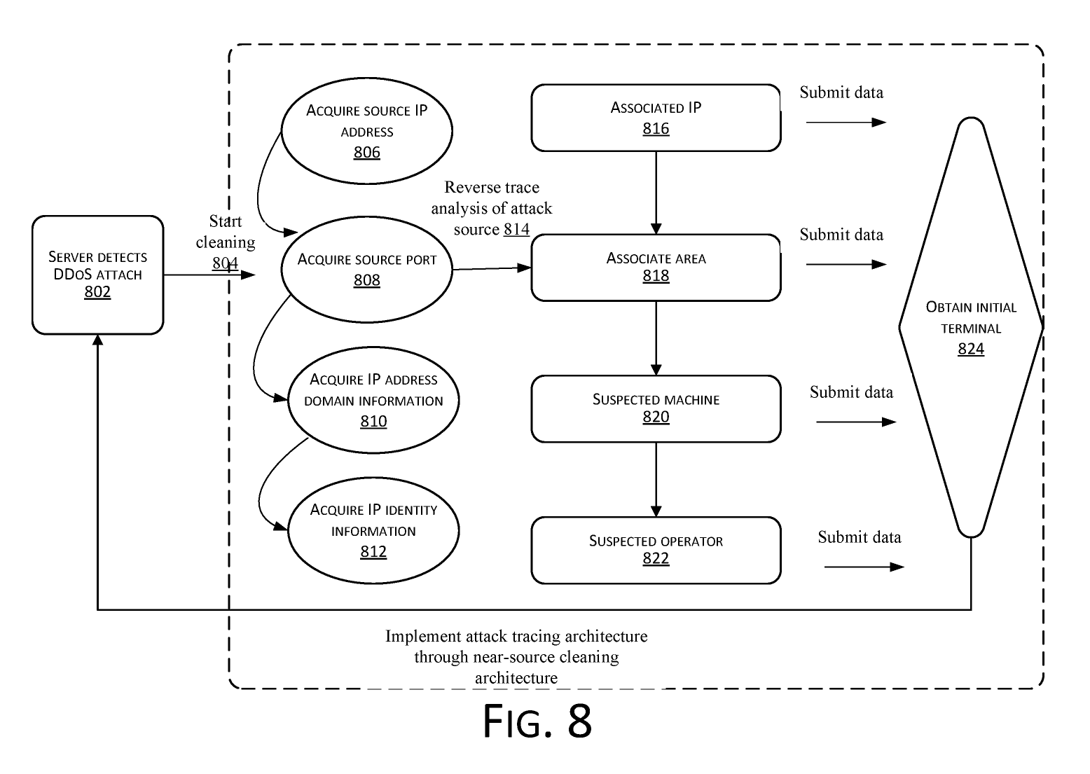

In combination with FIG. 7, based on Example embodiment 1 and Example embodiment 2, FIG. 8 is a schematic flowchart showing that a prevention and control system for a network attack performs a prevention and control method according to an example embodiment of the present disclosure. As shown in FIG. 8, the processing flow of the prevention and control system for a network attack is, for example, as follows:

Firstly, at 802, when the DDoS attack is detected at the server side, at 804, cleaning is started, and the metropolitan area device is coordinated (i.e., a prevention and control instruction is given).

Secondly, the local area network device, such as the routing device at the metropolitan area device side. acquires a quintuple (a source IP address, a source port, a destination address, a destination port, and a protocol type). For example, the metropolitan area device acquires the source IP address at 806, acquires the source port at 808, acquires the IP address domain information at 810, and acquires the IP identify information at 812.

Thirdly, the metropolitan area device side performs reverse tracing analysis of attack source at 814, and submits an associated IP 816 of IP communication, an associated area 818, a suspected machine 820, and a suspected operator 822 (i.e., the attacking terminal and the initial terminal mentioned in the example embodiment of the present disclosure).

Fourthly, an initial terminal that initiates the entire DDoS attack is located, and a prevention and control strategy is executed. At 824, the initial terminal is obtained.

In the prevention and control method for a network attack provided in the example embodiment of the present disclosure, descriptions are given by using the DDoS attack as an example. In the process of performing the DDoS attack, a botnet composed of the attacking terminal that sends the attack packet is a main attack source which harms the server side, wherein detection and cleaning of the botnet are a source defense solution of DOS (Denial of Service) and DDoS attacks that an operator faces. The prevention and control method for a network attack provided in the example embodiment of the present disclosure solves the problem of the botnet, the threat that the operator is subject to DOS and DDoS attacks will be reduced to the largest extent. In the above communication architecture, the DDoS solution transits from only passive detection, blocking, cleaning and the like to a source solution. The prevention and control method for a network attack provided in the example embodiment of the present disclosure may be used as a source solution of the DDoS to really solve the DDoS attack problem of the operator network in the future.

It should be noted that for ease of description, the foregoing method example embodiments are all described as a series of action combinations. However, those skilled in the art should understand that the present disclosure is not limited to the described sequence of the actions, because some steps may be performed in another sequence or at the same time according to the present disclosure. In addition, those skilled in the art should also understand that the example embodiments described in this specification are example, and involved actions and modules are not necessary to the present disclosure.

Based on the foregoing descriptions of the implementation manners, those skilled in the art may clearly understand that the prevention and control method for a network attack according to the present disclosure may be implemented by software plus a necessary universal hardware platform, and certainly may also be implemented by hardware. However, the former is a better implementation manner in most cases. Based on such understanding, the technical solutions of the present disclosure essentially, or the part contributing to the conventional techniques may be embodied in the form of a software product. The computer software product may be stored in a storage medium (such as a ROM/RAM, a magnetic disk, or an optical disc), and include several instructions that enable a terminal device (which may be a mobile phone, a computer, a server, a network device, or the like) to execute the method in the example embodiments of the present disclosure.

### Example Embodiment 3

According to the example embodiment of the present disclosure, an example embodiment of a prevention and control apparatus for a network attack configured to implement the foregoing method example embodiment is further provided. The apparatus provided in the above example embodiment of the present disclosure may run on a server.

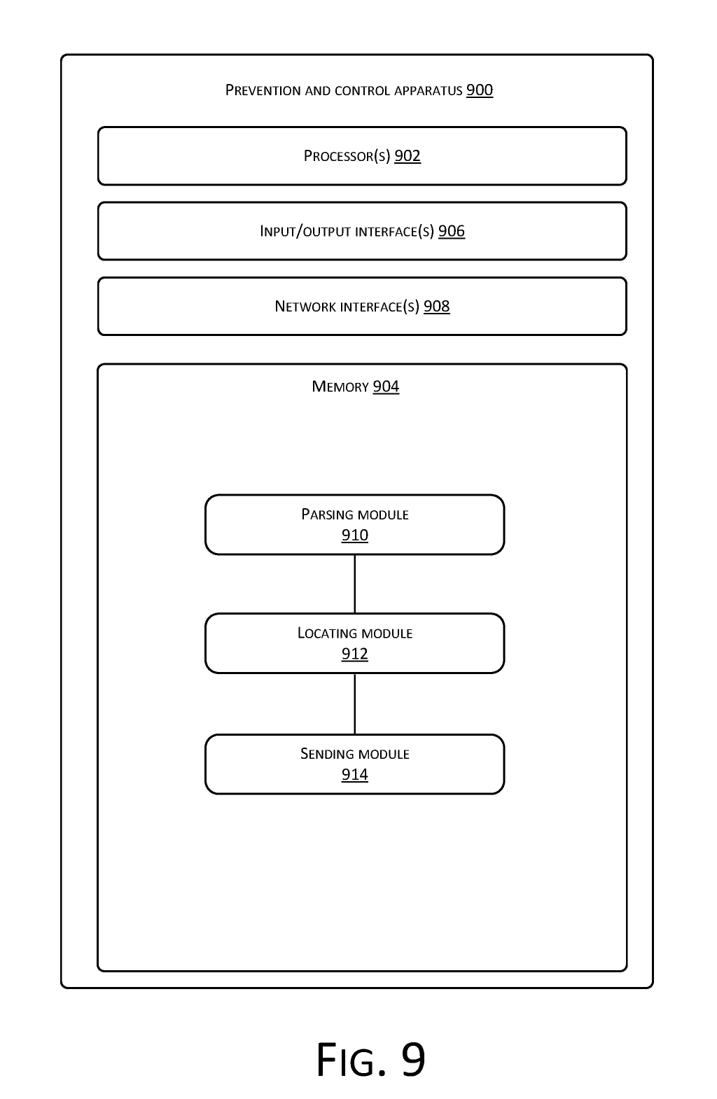

FIG. 9 is a schematic structural diagram of a prevention and control apparatus for a network attack according to Example embodiment 3 of the present disclosure.

As shown in FIG. 9, a prevention and control apparatus 900 for a network attack includes one or more processor(s) 902 or data processing unit(s) and memory 904. The prevention and control apparatus 900 may further include one or more input/output interface(s) 906 and one or more network interface(s) 908. The memory 904 is an example of computer readable media.

The memory 904 may store therein a plurality of modules or units including a parsing module 910, a locating module 912 and a sending module 914.

The parsing module 910 is configured to parse an attack packet when a network attack is detected, wherein the attack packet includes address information; the locating module 912 is configured to locate a first gateway device according to the address information; and the sending module 914 is configured to send a prevention and control instruction to the first gateway device, wherein the prevention and control instruction is used for instructing the first gateway device to perform security control on a terminal to which the attack packet belongs.

It is thus clear that according to the solution provided in Example embodiment 3 of the present disclosure, an attack packet is parsed when a network attack is detected, wherein the attack packet includes address information; a first gateway device is located according to the address information; a prevention and control instruction is sent to the first gateway device, wherein the prevention and control instruction is used for instructing the first gateway device to perform security control on a terminal to which the attack packet belongs, which achieves an objective of actively performing security control on network attacks by a server and a gateway device, thus achieving a technical effect of improving the defense efficiency, and solving the technical problem of low defense efficiency when a target server under attack defends passively due to the lack of techniques of monitoring and countering network attacks in conventional techniques.

It should be noted here that the parsing module 910, the locating module 912 and the sending module 914 correspond to step S202 to step S206 in Example embodiment 1, examples and application scenarios where the three modules and the corresponding steps are implemented are the same, but the three modules are not limited to the content disclosed in Example embodiment 1. It should be noted that as a part of the apparatus, the above modules may operate in the server 10 provided in Example embodiment 1, which may be implemented by software or by hardware.

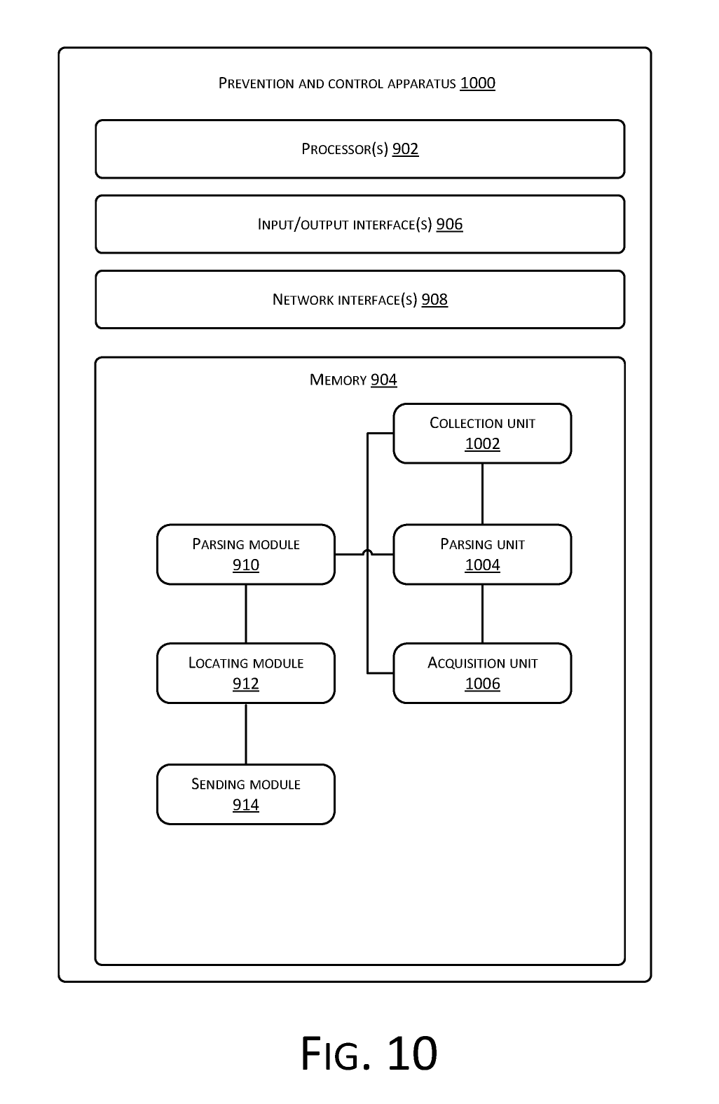

In an example embodiment, FIG. 10 is a schematic structural diagram of a prevention and control apparatus 1000 for a network attack according to Example embodiment 3 of the present disclosure. As shown in FIG. 10, the parsing module 910 includes: a collection unit 1002, a parsing unit 1004 and an acquisition unit 1006.

The collection unit 1002 is configured to collect the attack packet within a preset unit time; the parsing unit 1004 is configured to parse the attack packet to obtain the address information and traffic information of the attack packet; and the acquisition unit 1006 is configured to obtain an attack feature of the attack packet according to the traffic information and the address information, wherein the attack feature is a manner of impacting the traffic of a server by the attack packet based on the address information within the preset unit time.

It should be noted here that the collection unit 1002, the parsing unit 1004 and acquisition unit 1006 correspond to Step1 to Step3 of step S202 in Example embodiment 1, examples and application scenarios where the three modules and the corresponding steps are implemented are the same, but the three modules are not limited to the content disclosed in Example embodiment 1. It should be noted that as a part of the apparatus, the above modules may operate in the server 10 provided in Example embodiment 1, which may be implemented by software or by hardware.

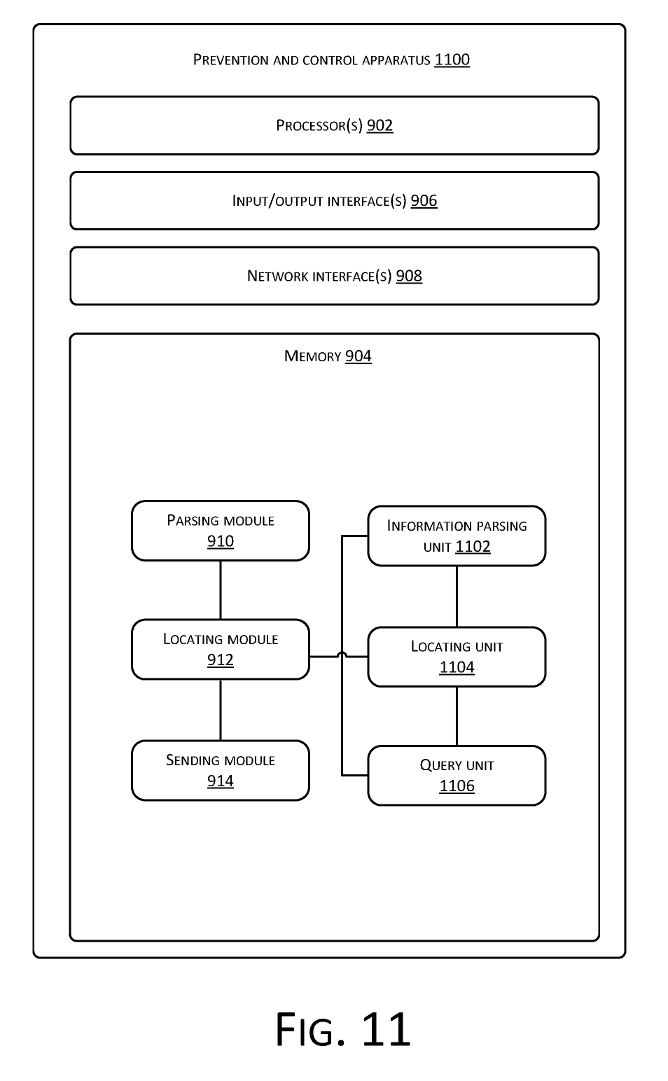

Further, in an example embodiment, FIG. 11 is a schematic structural diagram of another prevention and control apparatus 1100 for a network attack according to Example embodiment 3 of the present disclosure. As shown in FIG. 11, the locating module 912 includes: an information parsing unit 1102, a locating unit 1104, and a query unit 1106.

The information parsing unit 1102 is configured to parse the address information to obtain a source address of the attack packet; the locating unit 1104 is configured to match a location corresponding to the source address in a preset database to obtain a location to which the attack packet belongs; and the query unit 1106 is configured to query the database for a gateway device corresponding to the location, to obtain the first gateway device corresponding to the location to which the attack packet belongs.

It should be noted here that the information parsing unit 1102, the locating unit 1104 and the query unit 1106 correspond to Step1 to Step3 of step S204 in Example embodiment 1, examples and application scenarios where the three modules and the corresponding steps are implemented are the same, but the three modules are not limited to the content disclosed in Example embodiment 1. It should be noted that as a part of the apparatus, the above modules may operate in the server 10 provided in Example embodiment 1, which may be implemented by software or by hardware.

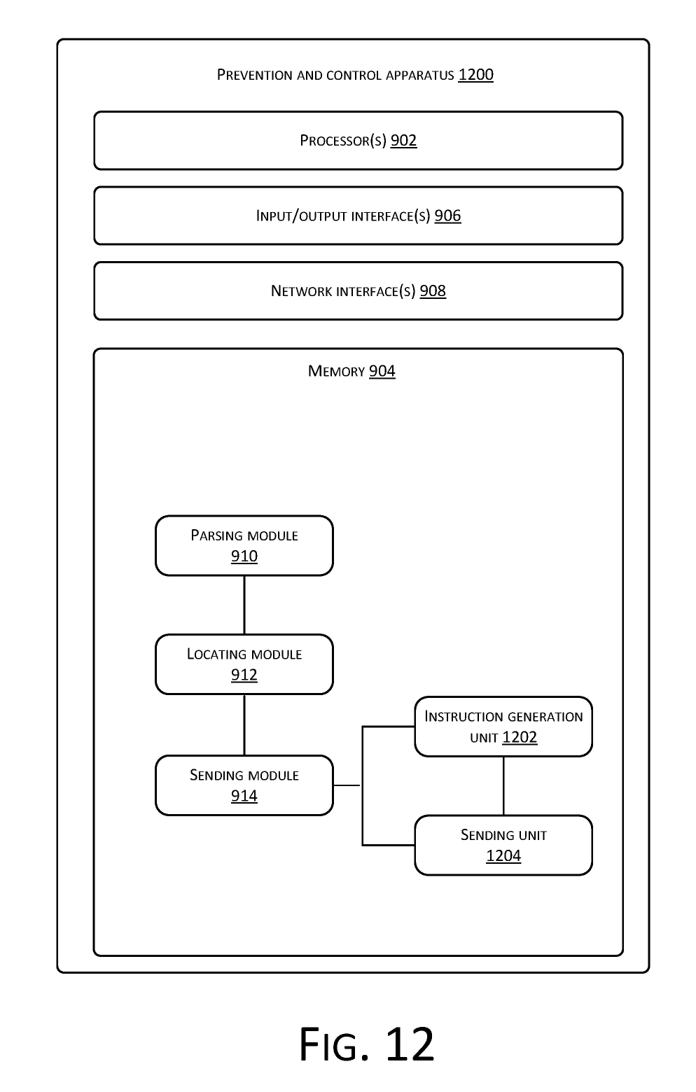

Further, in an example embodiment, FIG. 12 is a schematic structural diagram of yet another prevention and control apparatus 1200 for a network attack according to Example embodiment 3 of the present disclosure. As shown in FIG. 12, the sending module 914 includes: an instruction generation unit 1202 and a sending unit 1204.

The instruction generation unit 1202 is configured to generate a prevention and control instruction according to the attack feature; and the sending unit 1204 is configured to send the prevention and control instruction to the first gateway device.

It should be noted here that the instruction generation unit 1202 and the sending unit 1204 correspond to Step1 and Step2 of step S206 in Example embodiment 1, examples and application scenarios where the two modules and the corresponding steps are implemented are the same, but the two modules are not limited to the content disclosed in Example embodiment 1. It should be noted that as a part of the apparatus, the above modules may operate in the server 10 provided in Example embodiment 1, which may be implemented by software or by hardware.

In the prevention and control apparatus for a network attack provided in the example embodiment of the application, the example embodiment of the present disclosure provides a prevention and control network, which is different from the passive defense at the server side in conventional techniques. In the prevention and control network, a cleaning system is also deployed at the metropolitan area device side in addition to at the server side. As a result, when the server side detects a network attack, the source of the entire attack process, i.e., the initiating terminal of the entire network attack, is obtained by locating the city to which the initiating terminal of the attack packet belongs and cooperating with the metropolitan area device of the city to perform tracing and screening according to attack information of the attack packet. Security control is performed on the initiating terminal through the cleaning system of the metropolitan area device, to eliminate the attack network composed of the initiating terminal and completely eradicate a network attack initiated by the initiating terminal once again. Different from the passive defense at the server side in conventional techniques, in the prevention and control method for a network attack provided in the example embodiment of the present disclosure, in addition to the conventional prevention and control, the server side also acquires the source IP of the attack packet actively, performs locating, and cooperates with the metropolitan area device corresponding to the location to which the source IP belongs, thus achieving the effect of active defense, and enhancing the defense efficiency of the server side when facing network attacks.

### Example Embodiment 4

According to the example embodiment of the present disclosure, an example embodiment of a prevention and control apparatus for a network attack configured to implement the foregoing method example embodiment is further provided. The apparatus provided in the above example embodiment of the present disclosure may run on a metropolitan area device.

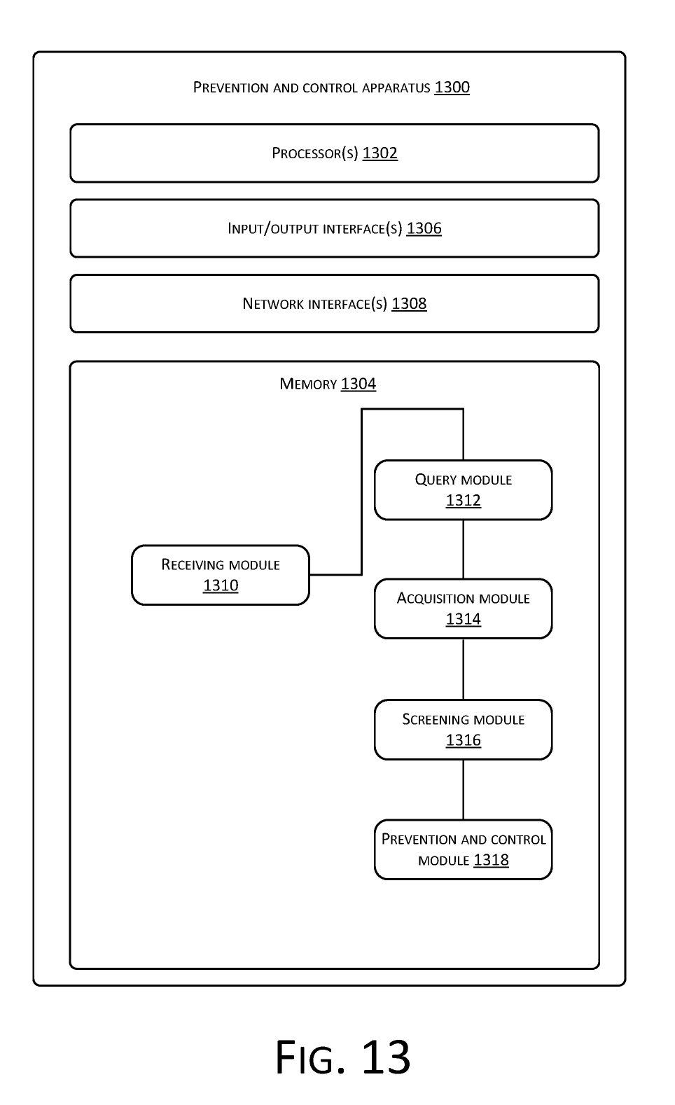

FIG. 13 is a schematic structural diagram of a prevention and control apparatus 1300 for a network attack according to Example embodiment 4 of the present disclosure.

As shown in FIG. 13, a prevention and control apparatus 1300 for a network attack includes one or more processor(s) 1302 or data processing unit(s) and memory 1304. The prevention and control apparatus 1300 may further include one or more input/output interface(s) 1306 and one or more network interface(s) 1308. The memory 1304 is an example of computer readable media.

The memory 1304 may store therein a plurality of modules or units including: a receiving module 1310, a query module 1312, an acquisition module 1314, a screening module 1316, and a prevention and control module 1318.

The receiving module 1310 is configured to receive a prevention and control instruction, wherein the prevention and control instruction includes address information of an attack packet received by an attacked server; the query module 1312 is configured to obtain by query, according to the address information, an attacking terminal that sends the attack packet; the acquisition module 1314 is configured to acquire port information of the attacking terminal, and obtain, according to the port information, computing devices in communication connection with the attacking terminal; the screening module 1316 is configured to screen, according to the port information, the computing devices in communication connection with the attacking terminal, to obtain an initial terminal that initiates the attack packet, wherein the attacking terminal sends the attack packet according to a control instruction of the initial terminal; and the prevention and control module 1318 is configured to control the initial terminal in a preset manner.

It is thus clear that according to the solution provided in Example embodiment 4 of the present disclosure, a prevention and control instruction is received, wherein the prevention and control instruction includes address information of an attack packet received by an attacked server; an attacking terminal that sends the attack packet is obtained by query according to the address information; port information of the attacking terminal is acquired, and computing devices in communication connection with the attacking terminal are obtained according to the port information; the computing devices in communication connection with the attacking terminal are screened according to the port information, to obtain an initial terminal that initiates the attack packet, wherein the attacking terminal sends the attack packet according to a control instruction of the initial terminal; and the initial terminal is controlled in a preset manner. Therefore, an objective of actively performing security control on network attacks by a server and a gateway device is achieved, thus achieving a technical effect of improving the defense efficiency, and solving the technical problem of low defense efficiency when a target server under attack defends passively due to the lack of techniques of monitoring and countering network attacks in conventional techniques.

It should be noted here that the receiving module 1310, the query module 1312, the acquisition module 1314, the screening module 1316, and the prevention and control module 1318 correspond to step S502 to step S510 in Example embodiment 2, examples and application scenarios where the five modules and the corresponding steps are implemented are the same, but the five modules are not limited to the content disclosed in Example embodiment 2. It should be noted that as a part of the apparatus, the above modules may operate in the metropolitan area device provided in Example embodiment 2, which may be implemented by software or by hardware.

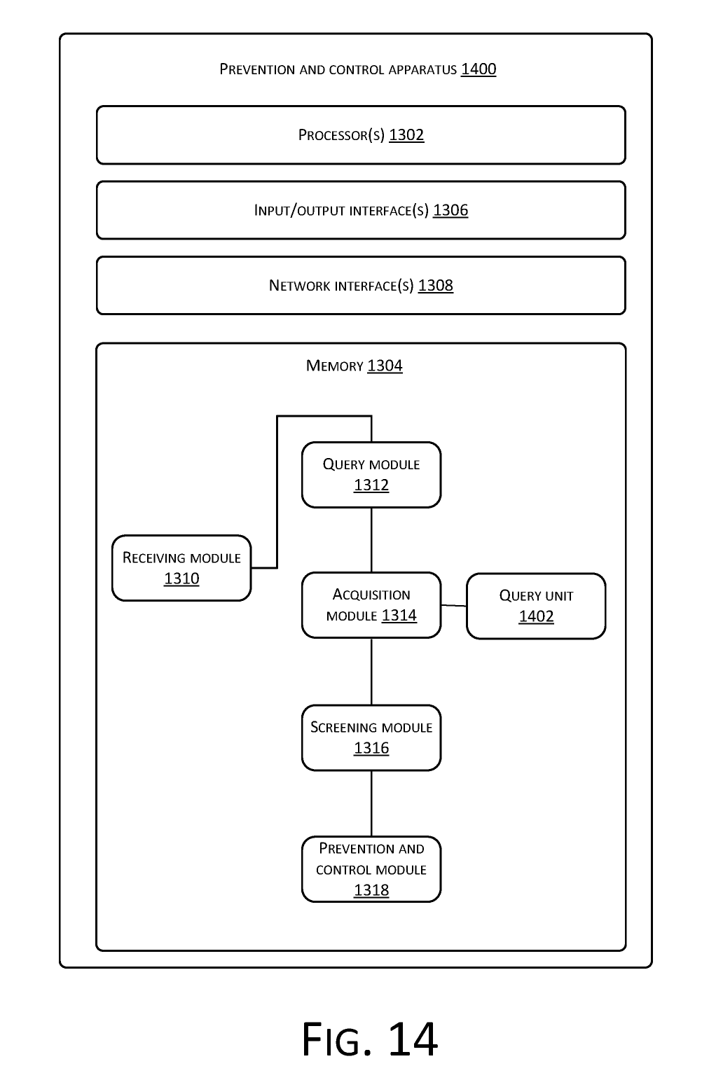

In an example embodiment, FIG. 14 is a schematic structural diagram of a prevention and control apparatus 1400 for a network attack according to Example embodiment 4 of the present disclosure. As shown in FIG. 14, the acquisition module 1314 includes: a query unit 1402.

The query unit 1402 is configured to query for, according to the port information, computing devices that communicate with the attacking terminal before the prevention and control instruction is received.

It should be noted here that the above query unit 1402 corresponds to Step1 in step S506 in Example embodiment 2, examples and application scenarios where the module and the corresponding step are implemented are the same, but the module is not limited to the content disclosed in Example embodiment 2. It should be noted that as a part of the apparatus, the above module may operate in the metropolitan area device provided in Example embodiment 2, which may be implemented by software or by hardware.

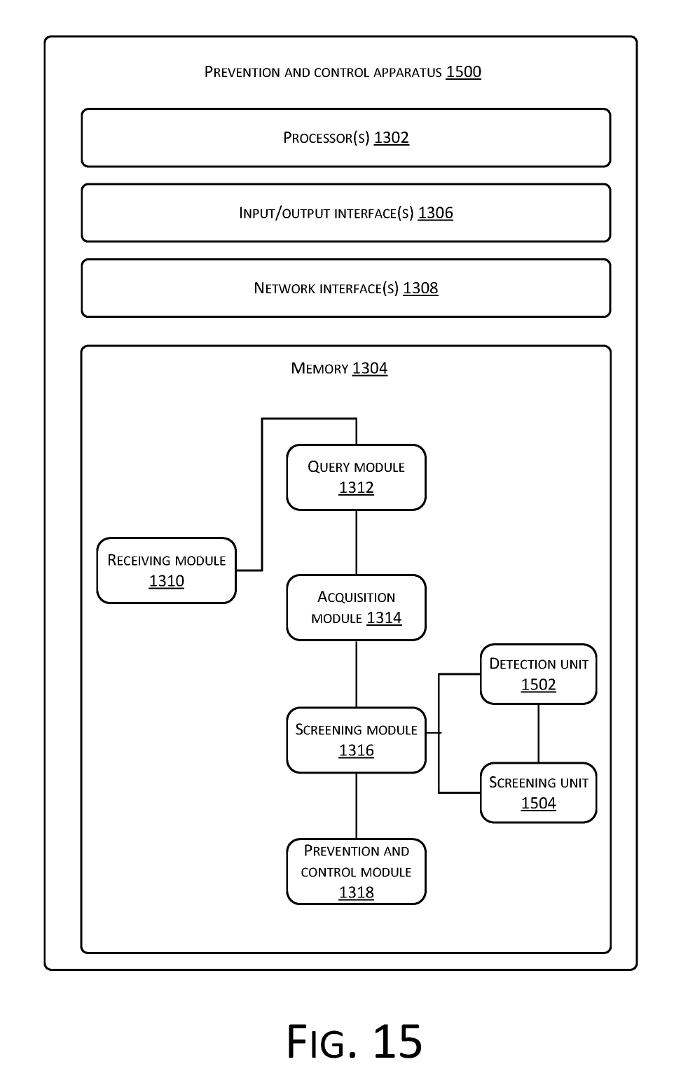

In an example embodiment, FIG. 15 is a schematic structural diagram of another prevention and control apparatus 1500 for a network attack according to Example embodiment 4 of the present disclosure. As shown in FIG. 15, the screening module 1316 includes: a detection unit 1502 and a screening unit 1504.

The detection unit 1502 is configured to, when the port information includes a source address, a destination address, a source port, a destination port and a protocol type, use an address of the attacking terminal as the destination address, and detect a source address that communicates with the destination address within a preset time for a number of times that is greater than a preset security value; and the screening unit 1504 is configured to use the computing device corresponding to the source address with the number of times of communication greater than the preset security value as the initial terminal.

It should be noted here that the detection unit 1502 and the screening unit 1504 correspond to Step1 and Step2 in step S508 in Example embodiment 2, examples and application scenarios where the two modules and the corresponding steps are implemented are the same, but the two modules are not limited to the content disclosed in Example embodiment 2. It should be noted that as a part of the apparatus, the above modules may operate in the metropolitan area device provided in Example embodiment 2, which may be implemented by software or by hardware.

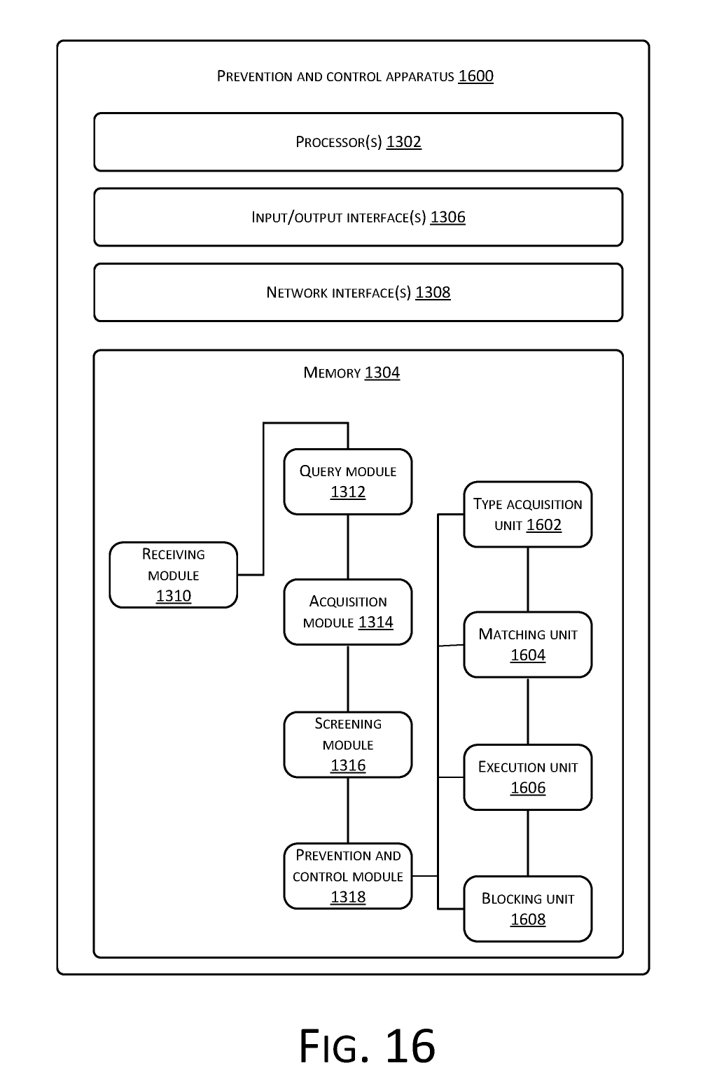

Further, in an example embodiment, FIG. 16 is a schematic structural diagram of yet another prevention and control apparatus 1600 for a network attack according to Example embodiment 4 of the present disclosure, as shown in FIG. 16, the prevention and control module 1318 includes: a type acquisition unit 1602, a matching unit 1604, an execution unit 1606, and a blocking unit 1608.

The type acquisition unit 1602 is configured to acquire a device type of the initial terminal; the matching unit 1604 is configured to determine a matching prevention and control strategy in a preset database according to the attack feature and the device type when the attack feature is a manner of impacting the traffic of a server by the attack packet based on the address information within a preset unit time; the execution unit 1606 is configured to interrupt a communication link between the attacking terminal and the initial terminal; and the blocking unit 1608 is configured to block the initial terminal according to the prevention and control strategy.

It should be noted here that the type acquisition unit 1602, the matching unit 1604, the execution unit 1606, and the blocking unit 1608 correspond to Step1 to Step4 in step S510 in Example embodiment 2, examples and application scenarios where the four modules and the corresponding steps are implemented are the same, but the four modules are not limited to the content disclosed in Example embodiment 2. It should be noted that as a part of the apparatus, the above modules may operate in the metropolitan area device provided in Example embodiment 2, which may be implemented by software or by hardware.

In the prevention and control method for a network attack provided in the example embodiment of the present disclosure, descriptions are given by using the DDoS attack as an example. In the process of performing the DDoS attack, a botnet composed of the attacking terminal that sends the attack packet is a main attack source which harms the server side, wherein detection and cleaning of the botnet are a source defense solution of DOS (Denial of Service) and DDoS attacks that an operator faces. The prevention and control method for a network attack provided in the example embodiment of the present disclosure solves the problem of the botnet, the threat that the operator is subject to DOS and DDoS attacks will be reduced to the largest extent. In the above communication architecture, the DDoS solution transits from only passive detection, blocking, cleaning and the like to a source solution. The prevention and control method for a network attack provided in the example embodiment of the present disclosure may be used as a source solution of the DDoS to really solve the DDoS attack problem of the operator network in the future.

### Example Embodiment 5

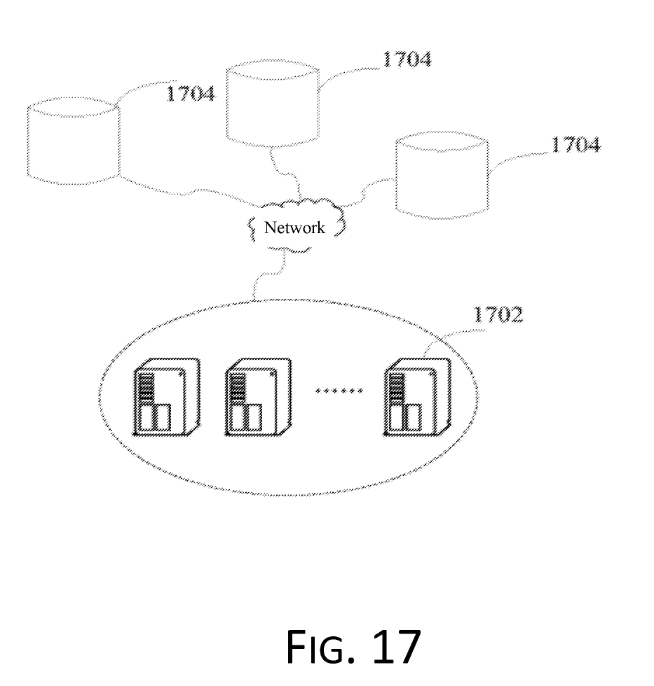

According to the example embodiment of the present disclosure, a system example embodiment configured to implement the example embodiment of the prevention and control method for a network attack is further provided. FIG. 17 is a schematic structural diagram of a prevention and control system for a network attack according to Example embodiment 5 of the present disclosure.

As shown in FIG. 17, the prevention and control system for a network attack includes: a server 1702, and one or more local area network devices such as the metropolitan area device 1704. The server 1702 is in communication connection with the metropolitan area device 1704, wherein the server 1702 is the prevention and control apparatus for a network attack of any of FIG. 9 to FIG. 12; and the metropolitan area device 1704 is the prevention and control apparatus for a network attack of any of FIG. 13 to FIG. 16.

### Example Embodiment 6

According to the example embodiment of the present disclosure, a storage medium is further provided. In an example embodiment, in this example embodiment, the above storage medium may be used to store program code executed by the prevention and control method for a network attack provided in Example embodiment 1.

In an example embodiment, in this example embodiment, the above storage medium may be located in any computer terminal of a computer terminal group in a computer network, or in any mobile terminal of a mobile terminal group.

In an example embodiment, in this example embodiment, the storage medium is configured to store program codes for performing the following steps: parsing an attack packet when a network attack is detected, wherein the attack packet includes address information; locating a first gateway device according to the address information; and sending a prevention and control instruction to the first gateway device, wherein the prevention and control instruction is used for instructing the first gateway device to perform security control on a terminal to which the attack packet belongs.

In an example embodiment, in this example embodiment, the storage medium is configured to store program codes for performing the following steps: collecting the attack packet within a preset unit time; parsing the attack packet to obtain the address information and traffic information of the attack packet; and obtaining an attack feature of the attack packet according to the traffic information and the address information, wherein the attack feature is a manner of impacting the traffic of a server by the attack packet based on the address information within the preset unit time.

In an example embodiment, in this example embodiment, the storage medium is configured to store program codes for performing the following steps: parsing the address information to obtain a source address of the attack packet; matching a location corresponding to the source address in a preset database to obtain a location to which the attack packet belongs; and querying the database for a gateway device corresponding to the location to obtain the first gateway device corresponding to the location to which the attack packet belongs.

In an example embodiment, in this example embodiment, the storage medium is configured to store program codes for performing the following steps: generating a prevention and control instruction according to the attack feature; and sending the prevention and control instruction to the first gateway device.

In an example embodiment, in this example embodiment, the storage medium may include, but not limited to, any medium that may store program code, such as a USB flash drive, a Read-Only Memory (ROM), a Random Access Memory (RAM), a removable hard disk, a magnetic disk, or an optical disc.

In an example embodiment, reference may be made to the example described in Example embodiment 1 for the specific example in this example embodiment. This example embodiment is not described in detail here.

The sequence numbers of the example embodiments of the present disclosure are merely for the convenience of description, and do not imply the preference among the example embodiments.

In the foregoing example embodiments of the present disclosure, the description of each example embodiment has its own focus. For the content that is not detailed in a certain example embodiment, reference may be made to the relevant description of another example embodiment.

In the several example embodiments provided in the present disclosure, it should be understood that the disclosed technical content may be implemented in another manner. The described apparatus example embodiments are only exemplary. For example, division of the unit is merely division of a logical function and division in another manner may exist in actual implementation, for example, a plurality of units or components may be combined or integrated into another system, or some features may be ignored or not performed. In addition, the mutual coupling or direct coupling or communication connection displayed or discussed may be indirect coupling or communication connection implemented by using some interfaces, the units or modules, and may be implemented electrically or in another form.

The units described as separate parts may or may not be physically separate, and parts displayed as units may or may not be physical units, may be located in one location, or may be distributed on a plurality of network units. Some or all of the units may be selected according to actual needs to achieve the objectives of the solutions of the example embodiments.

In addition, functional units in the example embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer readable storage medium. Based on such understanding, the technical solutions of the present disclosure essentially, or the part that makes contributions to the conventional techniques, or all or a part of the technical solutions may be implemented in a form of a software product. The computer software product is stored in a storage medium, and includes several instructions for instructing a computer device (which may be a personal computer, a server, a network device or the like) to perform all or a part of the steps of the methods described in the example embodiments of the present disclosure. The foregoing storage medium includes: any medium that may store program codes, such as a USB flash drive, a Read-Only Memory (ROM), a Random Access Memory (RAM), a removable hard disk, a magnetic disk, or an optical disc.

The foregoing are only example embodiments of the present disclosure. It should be noted by those of ordinary skill in the art that several improvements and modifications may be made without departing from the principle of the present disclosure. These improvements and modifications should be construed as falling within the protection scope of the present disclosure.

The present disclosure may further be understood with clauses as follows.

Clause 1. A prevention and control method for a network attack, comprising:

parsing an attack packet when a network attack is detected, wherein the attack packet comprises address information;

locating a first gateway device according to the address information; and

sending a prevention and control instruction to the first gateway device, wherein the prevention and control instruction is used for instructing the first gateway device to perform security control on a terminal to which the attack packet belongs.

Clause 2. The method of clause 1, wherein the step of parsing an attack packet comprises:

collecting the attack packet within a preset unit time;

parsing the attack packet to obtain the address information and traffic information of the attack packet; and

obtaining an attack feature of the attack packet according to the traffic information and the address information, wherein the attack feature is a manner of impacting the traffic of a server by the attack packet based on the address information within the preset unit time.

Clause 3. The method of clause 2, wherein the step of locating a first gateway device according to the address information comprises:

parsing the address information to obtain a source address of the attack packet;

matching a location corresponding to the source address in a preset database to obtain a location to which the attack packet belongs; and

querying the database for a gateway device corresponding to the location, to obtain the first gateway device corresponding to the location to which the attack packet belongs.

Clause 4. The method of clause 2, wherein the step of sending a prevention and control instruction to the first gateway device comprises:

generating a prevention and control instruction according to the attack feature; and

sending the prevention and control instruction to the first gateway device.

Clause 5. A prevention and control method for a network attack, comprising:

receiving a prevention and control instruction, wherein the prevention and control instruction comprises address information of an attack packet received by an attacked server;

obtaining by query, according to the address information, an attacking terminal that sends the attack packet;

acquiring port information of the attacking terminal, and obtaining, according to the port information, computing devices in communication connection with the attacking terminal;

screening, according to the port information, the computing devices in communication connection with the attacking terminal, to obtain an initial terminal that initiates the attack packet, wherein the attacking terminal sends the attack packet according to a control instruction of the initial terminal; and

controlling the initial terminal in a preset manner.

Clause 6. The method of clause 5, wherein the step of obtaining, according to the port information, computing devices in communication connection with the attacking terminal comprises:

querying for, according to the port information, computing devices that communicate with the attacking terminal before the prevention and control instruction is received.

Clause 7. The method of clause 6, wherein the step of screening, according to the port information, the computing devices in communication connection with the attacking terminal, to obtain an initial terminal that initiates the attack packet comprises:

when the port information comprises a source address, a destination address, a source port, a destination port and a protocol type, using an address of the attacking terminal as the destination address, and detecting a source address that communicates with the destination address within a preset time for a number of times that is greater than a preset security value; and

using the computing device that has communication with the source address with the number of times of communication that is greater than the preset security value as the initial terminal.

Clause 8. The method of clause 7, wherein when the prevention and control instruction further comprises an attack feature, the step of controlling the initial terminal in a preset manner comprises:

acquiring a device type of the initial terminal;

determining a matching prevention and control strategy in a preset database according to the attack feature and the device type when the attack feature is a manner of impacting the traffic of a server by the attack packet based on the address information within a preset unit time;

interrupting a communication link between the attacking terminal and the initial terminal; and

blocking the initial terminal according to the prevention and control strategy.

Clause 9. A prevention and control apparatus for a network attack, comprising:

a parsing module configured to parse an attack packet when a network attack is detected, wherein the attack packet comprises address information;

a locating module configured to locate a first gateway device according to the address information; and

a sending module configured to send a prevention and control instruction to the first gateway device, wherein the prevention and control instruction is used for instructing the first gateway device to perform security control on a terminal to which the attack packet belongs.

Clause 10. The prevention and control apparatus of clause 9, wherein the parsing module comprises:

a collection unit configured to collect the attack packet within a preset unit time;

a parsing unit configured to parse the attack packet to obtain the address information and traffic information of the attack packet; and

an acquisition unit configured to obtain an attack feature of the attack packet according to the traffic information and the address information, wherein the attack feature is a manner of impacting the traffic of a server by the attack packet based on the address information within the preset unit time.

Clause 11. The prevention and control apparatus of clause 10, wherein the locating module comprises:

an information parsing unit configured to parse the address information to obtain a source address of the attack packet;

a locating unit configured to match a location corresponding to the source address in a preset database to obtain a location to which the attack packet belongs; and

a query unit configured to query the database for a gateway device corresponding to the location to obtain the first gateway device corresponding to the location to which the attack packet belongs.

Clause 12. The prevention and control apparatus of clause 10, wherein the sending module comprises:

an instruction generation unit configured to generate a prevention and control instruction according to the attack feature; and

a sending unit configured to send the prevention and control instruction to the first gateway device.

Clause 13. A prevention and control apparatus for a network attack, comprising:

a receiving module configured to receive a prevention and control instruction, wherein the prevention and control instruction comprises address information of an attack packet received by an attacked server;

a query module configured to obtain by query, according to the address information, an attacking terminal that sends the attack packet;

an acquisition module configured to acquire port information of the attacking terminal, and obtain, according to the port information, computing devices in communication connection with the attacking terminal;

a screening module configured to screen, according to the port information, the computing devices in communication connection with the attacking terminal, to obtain an initial terminal that initiates the attack packet, wherein the attacking terminal sends the attack packet according to a control instruction of the initial terminal; and

a prevention and control module configured to control the initial terminal in a preset manner.

Clause 14. The prevention and control apparatus of clause 13, wherein the acquisition module comprises:

a query unit configured to query for, according to the port information, computing devices that communicate with the attacking terminal before the prevention and control instruction is received.

Clause 15. The prevention and control apparatus of clause 14, wherein the screening module comprises:

a detection unit configured to: when the port information comprises a source address, a destination address, a source port, a destination port and a protocol type, use an address of the attacking terminal as the destination address, and detect a source address that communicates with the destination address within a preset time for a number of times that is greater than a preset security value; and

a screening unit configured to use the computing device corresponding to the source address with the number of times of communication greater than the preset security value as the initial terminal.

Clause 16. The prevention and control apparatus of clause 15, wherein the prevention and control module comprises:

a type acquisition unit configured to, when the prevention and control instruction further comprises an attack feature, acquire a device type of the initial terminal;

a matching unit configured to determine a matching prevention and control strategy in a preset database according to the attack feature and the device type when the attack feature is a manner of impacting the traffic of a server by the attack packet based on the address information within a preset unit time;

an execution unit configured to interrupt a communication link between the attacking terminal and the initial terminal; and

a blocking unit configured to block the initial terminal according to the prevention and control strategy.

Clause 17. A prevention and control system for a network attack, comprising: a server and a metropolitan area device, the server being in communication connection with the metropolitan area device, wherein

the server is the prevention and control apparatus for a network attack of any of clauses 9 to 12; and

the metropolitan area device is the prevention and control apparatus for a network attack of any of clauses 13 to 16.

What is claimed is:

1. A method comprising:
detecting a network attack;
parsing an attack packet of the network attack, the attack packet including address information of the attack packet;
locating a gateway device according to the address information; and
sending a first instruction to the gateway device, the first instruction instructing the gateway device to perform security control on a terminal to which the attack packet belongs.

2. The method of claim 1, wherein the parsing the attack packet includes:
collecting the attack packet within a preset time;
parsing the attack packet to obtain the address information and traffic information of the attack packet; and
obtaining an attack feature of the attack packet according to the traffic information and the address information.

3. The method of claim 2, wherein the attack feature includes a manner of impacting a traffic of a server by the attack packet based on the address information within the preset time.

4. The method of claim 2, wherein the locating the gateway device according to the address information includes:
parsing the address information to obtain a source address of the attack packet;
using the source address of the attack packet to find the location to which the attack packet belongs; and
querying the database to obtain the gateway device corresponding to the location.

5. The method of claim 4, wherein the using the source address of the attack packet to find the location to which the attack packet belongs includes:
matching the location from the database according to the source address.

6. The method of claim 2, wherein the sending the prevention and control instruction to the gateway device includes:
generating the prevention and control instruction according to the attack feature; and
sending the prevention and control instruction to the gateway device.

7. The method of claim 1, wherein the first instruction instructs the gateway device to perform security control on the terminal which the attack packet is from or initiated.

8. The method of claim 1, wherein the gateway device routes traffic information from the terminal to a network.

9. A method comprising:
receiving a first instruction including address information of an attack packet received by an attacked server;
obtaining by query, according to the address information, an attacking terminal that sends the attack packet;
acquiring port information of the attacking terminal;
obtaining, according to the port information, computing devices in communication connection with the attacking terminal; and
screening, according to the port information, the computing devices in communication connection with the attacking terminal, to obtain an initial terminal that initiates the attack packet.

10. The method of claim 9, wherein the attacking terminal sends the attack packet according to a control instruction of an initial terminal.

11. The method of claim 9, wherein the obtaining, according to the port information, computing devices in communication connection with the attacking terminal include:
querying for, according to the port information, computing devices that communicate with the attacking terminal before the first instruction is received.

12. The method of claim 9, wherein the port information includes:
a source address;
a destination address; a source port;
a destination port; and
a protocol type.

13. The method of claim 12, wherein the screening, according to the port information, the computing devices in communication connection with the attacking terminal, to obtain the initial terminal that initiates the attack packet includes:
using a first address of the attacking terminal as the destination address;
detecting a second address that communicates with the destination address within a preset time more than a preset number of times as the source address; and
using a computing device that communicates with the source address more than a preset value as the initial terminal.

14. The method of claim 9, further comprising controlling the initial terminal according to a preset manner.

15. The method of claim 14, wherein the controlling the initial terminal according to the preset manner includes blocking the initial terminal.

16. The method of claim 14, wherein the first instruction further includes an attack feature.

17. The method of claim 16, wherein the attack feature includes a manner of impacting a traffic of a server by the attack packet based on the address information within a preset time.

18. The method of claim 17, wherein the controlling the initial terminal according to the preset manner includes:
acquiring a device type of the initial terminal;
matching a first strategy from a preset database according to the device type and the attack feature;
interrupting a communication between the attacking terminal and the initial terminal; and
blocking the initial terminal according to the first strategy.

19. A system comprising:
a server, the server including:
first one or more processors; and
first one or more memories storing thereon computer-readable instructions that, when executed by the first one or more processors, cause the first one or more processors to perform acts comprising:
detecting a network attack;
parsing an attack packet of the network attack, the attack packet including address information of the attack packet;
locating a gateway device according to the address information; and
sending a first instruction to the gateway device, the first instruction instructing the gateway device to perform security control on a terminal to which the attack packet belongs.

20. The system of claim 19, further comprising:
a network device, the network device including:
second one or more processors; and
second one or more memories storing thereon computer-readable instructions that, when executed by the second one or more processors, cause the second one or more processors to perform acts comprising:
receiving the first instruction including address information of an attack packet received by an attacked server;
obtaining by query, according to the address information, an attacking terminal that sends the attack packet;
acquiring port information of the attacking terminal;
obtaining, according to the port information, computing devices in communication connection with the attacking terminal; and
screening, according to the port information, the computing devices in communication connection with the attacking terminal, to obtain an initial terminal that initiates the attack packet.
